(19) United States
(12) Patent Application Publication
(10) Pub. No.: US 2026/0058708 A1
(43) Pub. Date: Feb. 26, 2026

(54) System and Method for Machine Learning Based CSI Codebook Generation and CSI Reporting

(71) Applicant: Huawei Technologies Co., Ltd., Shenzhen (CN)

(72) Inventors: Weimin Heather Xiao, Hoffman Estates, IL (US); Zhigang Rong, San Diego, CA (US); Baoling S. Sheen, Overland Park, KS (US); Renjian Zhao, Basking Ridge, NJ (US)

(21) Appl. No.: 19/330,338

(22) Filed: Sep. 16, 2025

Related U.S. Application Data
(63) Continuation of application No. PCT/US2024/020145, filed on Mar. 15, 2024.
(60) Provisional application No. 63/490,877, filed on Mar. 17, 2023.
(60) Provisional application No. 63/494,664, filed on Apr. 6, 2023.

(51) Int. Cl. H04B 7/06

(52) U.S. Cl. CPC H04B 7/0626; H04B 7/0658

(57) ABSTRACT

A system and method for a wireless device to derive a channel state information (CSI) codebook based on a decoder and a vector quantization codebook, receive a reference signal from a base station, derive an estimated channel from the reference signal, select an entry from the CSI codebook based on the estimated channel and a selection criterion, and report an index of the selected entry to the base station. The wireless device may receive a subset indication, derive therefrom a second CSI codebook, and select the CSI codebook entry from the second CSI codebook. A CSI compression machine learning (ML) system and vector quantization codebook may be obtained by a network controller. The decoder may be a part of the CSI compression ML system, the vector quantization codebook may be based on an encoder of the CSI compression ML system, and they may be sent to the wireless device.

### CROSS-REFERENCE TO RELATED APPLICATIONS

This application is a continuation of International Patent Application PCT/US2024/020145 filed Mar. 15, 2024 and entitled “System and Method for Machine Learning Based CSI Codebook Generation and CSI Reporting, which claims priority to U.S. Provisional Application 63/494,664 filed Apr. 6, 2023, entitled “System and Method for Machine Learning Based CSI Codebook Generation and CSI Reporting” and U.S. Provisional Application 63/490,877 filed Mar. 17, 2023, entitled “System and Method for Machine Learning Based CSI Codebook Generation and CSI Reporting,”. The disclosures of the aforementioned applications are hereby incorporated by reference in their entireties.

### TECHNICAL FIELD

The present disclosure relates generally to methods and apparatus for digital communications and, in particular embodiments, to system and method for machine learning based channel state information (CSI) codebook generation and CSI reporting.

### BACKGROUND

Wireless data traffic has been increasing at a rapid rate and this trend is expected to accelerate with the increasing use of video and the rise of the Internet-of-Things (IoT). To address this demand, the wireless industry is moving to its fifth generation (5G) and beyond, cellular technology that will use massive multiple input multiple output (MIMO) technology to offer multi-Gigabit-per-second (Gbps) data rates to a mobile device.

### SUMMARY

A first aspect relates to a method performed by a wireless device, the method comprising: deriving a channel state information (CSI) codebook based on a decoder and a vector quantization codebook; receiving a reference signal from a base station; deriving an estimated channel according to the reference signal; selecting a CSI codebook entry from the CSI codebook based on the estimated channel and a selection criterion; and reporting an index of the CSI codebook entry to the base station.

Optionally, in any of the preceding aspects, another implementation of the aspect further includes: receiving the decoder; and receiving the vector quantization codebook.

Optionally, in any of the preceding aspects, another implementation of the aspect provides the CSI codebook is a first CSI codebook, the method further comprising: receiving a subset indication of a subset of the first CSI codebook; and deriving a second CSI codebook from the first CSI codebook and the subset indication, wherein selecting a CSI codebook entry from the CSI codebook comprises selecting the CSI codebook entry from the second CSI codebook based on the estimated channel and a selection criterion.

Optionally, in any of the preceding aspects, another implementation of the aspect provides the subset indication is received from the base station.

Optionally, in any of the preceding aspects, another implementation of the aspect provides the subset indication comprises information identifying entries in the first CSI codebook that are included in the second CSI codebook; and the second CSI codebook comprises only the entries in the first CSI codebook that are identified in the subset indication.

Optionally, in any of the preceding aspects, another implementation of the aspect provides the first CSI codebook comprises K entries and the second CSI codebook comprises L entries; and the subset indication comprises a bitmap of length K bits with L bits equal to 1, where each bit of the subset indication corresponds to an entry of the first CSI codebook, and the entries in the first CSI codebook whose corresponding bits in the subset indication are equal to 1 are entries in the second CSI codebook.

Optionally, in any of the preceding aspects, another implementation of the aspect provides the decoder is received from a network server, a base station, or a device producer.

Optionally, in any of the preceding aspects, another implementation of the aspect provides the vector quantization codebook is received from a network server, a base station, or a device producer.

Optionally, in any of the preceding aspects, another implementation of the aspect provides the decoder and the vector quantization codebook are received from a single source.

Optionally, in any of the preceding aspects, another implementation of the aspect provides the vector quantization codebook is received from the base station.

Optionally, in any of the preceding aspects, another implementation of the aspect provides the decoder and the vector quantization codebook are received from different sources.

Optionally, in any of the preceding aspects, another implementation of the aspect provides deriving the CSI codebook comprises passing vector quantization codebook entries through the decoder.

Optionally, in any of the preceding aspects, another implementation of the aspect provides the selection criterion comprises a maximum squared generalized cosine similarity (SGCS) or a generalized cosine similarity (GCS) between the CSI codebook entry and the estimated channel.

Optionally, in any of the preceding aspects, another implementation of the aspect provides the selection criterion comprises a maximum signal to interference and noise ratio (SINR), a modulation and coding scheme (MCS) level, a channel quality indicator (CQI), or a data rate.

Optionally, in any of the preceding aspects, another implementation of the aspect further includes reporting to the base station a measure of CSI report accuracy.

Optionally, in any of the preceding aspects, another implementation of the aspect provides the CSI report accuracy is a quantitative value of an SGCS or a GCS between the CSI codebook entry and the estimated channel.

Optionally, in any of the preceding aspects, another implementation of the aspect provides the decoder is a decoder part of an autoencoder machine learning (ML) model.

A second aspect relates to a method performed by a first network controller, the method comprising: obtaining a channel state information (CSI) compression machine learning (ML) system, wherein the CSI compression ML system comprises an encoder and a decoder; obtaining a vector quantization codebook based on the encoder; transmitting the decoder to a wireless device; transmitting the vector quantization codebook to the wireless device; transmitting a reference signal to the wireless device; receiving an index x from the wireless device; deriving a precoding vector based on the index x, the decoder, and the vector quantization codebook; and transmitting a signal based on the precoding vector to the wireless device.

Optionally, in any of the preceding aspects, another implementation of the aspect provides obtaining the CSI compression ML system comprises obtaining the CSI compression ML system using a first CSI dataset.

Optionally, in any of the preceding aspects, another implementation of the aspect further includes training the CSI compression ML system using the first CSI dataset.

Optionally, in any of the preceding aspects, another implementation of the aspect further includes obtaining the CSI compression ML system from a second network controller.

Optionally, in any of the preceding aspects, another implementation of the aspect further includes training the vector quantization codebook using the encoder and a second CSI dataset.

Optionally, in any of the preceding aspects, another implementation of the aspect further includes obtaining the vector quantization codebook from a second network controller.

Optionally, in any of the preceding aspects, another implementation of the aspect provides deriving the precoding vector comprises passing an entry of the vector quantization codebook having the index x through the decoder and, based on an output of the decoder, deriving the precoding vector.

Optionally, in any of the preceding aspects, another implementation of the aspect further includes, prior to transmitting the reference signal to the wireless device: deriving a subset of a CSI codebook; and transmitting a subset indication of the subset of the CSI codebook to the wireless device, wherein the precoding vector is derived based on the index x and the subset of the CSI codebook.

A third aspect relates to a method performed by a wireless device, the method comprising: receiving a channel state information (CSI) codebook; receiving a reference signal from a base station; deriving an estimated channel according to the reference signal; selecting a CSI codebook entry from the CSI codebook based on the estimated channel and a selection criterion; and reporting an index of the CSI codebook entry to the base station.

Optionally, in any of the preceding aspects, another implementation of the aspect provides the CSI codebook is a first CSI codebook, the method further comprising: receiving a subset indication of a subset of the first CSI codebook; and deriving a second CSI codebook from the first CSI codebook and the subset indication, wherein selecting a CSI codebook entry from the CSI codebook comprises selecting the CSI codebook entry from the second CSI codebook based on the estimated channel and a selection criterion.

Optionally, in any of the preceding aspects, another implementation of the aspect provides the subset indication is received from the base station.

Optionally, in any of the preceding aspects, another implementation of the aspect provides the subset indication comprises information identifying entries in the first CSI codebook that are included in the second CSI codebook; and the second CSI codebook comprises only the entries in the first CSI codebook that are identified in the subset indication.

Optionally, in any of the preceding aspects, another implementation of the aspect provides the first CSI codebook comprises K entries and the second CSI codebook comprises L entries; and the subset indication comprises a bitmap of length K bits with L bits equal to 1, where each bit of the subset indication corresponds to an entry of the first CSI codebook, and the entries in the first CSI codebook whose corresponding bits in the subset indication are equal to 1 are entries in the second CSI codebook.

Optionally, in any of the preceding aspects, another implementation of the aspect provides the first CSI codebook is received from a network server, a base station, or a device producer.

Optionally, in any of the preceding aspects, another implementation of the aspect provides the selection criterion comprises a maximum squared generalized cosine similarity (SGCS) or a generalized cosine similarity (GCS) between the CSI codebook entry and the estimated channel.

Optionally, in any of the preceding aspects, another implementation of the aspect provides the selection criterion comprises a maximum signal to interference and noise ratio (SINR), a modulation and coding scheme (MCS) level, a channel quality indicator (CQI), or a data rate when the CSI codebook entry is applied as precoding for transmission over the estimated channel.

Optionally, in any of the preceding aspects, another implementation of the aspect further includes reporting to the base station a measure of CSI report accuracy.

Optionally, in any of the preceding aspects, another implementation of the aspect provides the CSI report accuracy is a quantitative value of an SGCS or a GCS between the CSI codebook entry and the estimated channel.

A fourth aspect relates to a network apparatus, comprising a memory configured to store computer executable instructions; and a processor coupled to the memory and configured to execute the computer executable instructions to perform the method of any of the first, second, or third aspects.

Optionally, in any of the preceding aspects, another implementation of the aspect provides the memory comprises two or more memory components and the processor comprises two or more processor components.

A fifth aspect relates to a non-transitory computer readable storage medium comprising a computer program product for use by a network apparatus, the computer program product comprising computer executable instructions stored on the non-transitory computer readable storage medium that, when executed by one or more processors, cause the network apparatus to execute the method of any of the first, second, or third aspects.

A sixth aspect relates to a network apparatus, comprising: a receiving means for receiving a reference signal; a transmitting means for reporting an index of a channel state information (CSI) codebook entry; and a processing means for: deriving a CSI codebook based on a decoder and a vector quantization codebook; receiving the reference signal from a base station; deriving an estimated channel according to the reference signal; selecting the CSI codebook entry from the CSI codebook based on the estimated channel and a selection criterion; and reporting the index of the CSI codebook entry to the base station.

Optionally, in any of the preceding aspects, another implementation of the aspect provides the processing means is further configured to receive the decoder and the vector quantization codebook.

Optionally, in any of the preceding aspects, another implementation of the aspect provides the processing means is further configured to derive the CSI codebook by passing vector quantization codebook entries through the decoder.

Optionally, in any of the preceding aspects, another implementation of the aspect provides the CSI codebook is a first CSI codebook and the processing means is further configured to: receive a subset indication of a subset of the first CSI codebook; and derive a second CSI codebook from the first CSI codebook and the subset indication, wherein selecting a CSI codebook entry from the CSI codebook comprises selecting the CSI codebook entry from the second CSI codebook based on the estimated channel and a selection criterion.

Optionally, in any of the preceding aspects, another implementation of the aspect provides the network apparatus is further configured to perform any of the methods of the first aspect.

A seventh aspect relates to a network apparatus, comprising: a receiving means for receiving an index x; a transmitting means for transmitting a decoder, a vector quantization codebook, a reference signal, and a signal; a processing means for: obtaining a channel state information (CSI) compression machine learning (ML) system, wherein the CSI compression ML system comprises an encoder and the decoder; obtaining the vector quantization codebook based on the encoder; transmitting the decoder, the vector quantization codebook, and the reference signal to a wireless device; receiving the index x from the wireless device; deriving a precoding vector based on the index x, the decoder, and the vector quantization codebook; and transmitting the signal to the wireless device, wherein the signal is based on the precoding vector.

Optionally, in any of the preceding aspects, another implementation of the aspect provides the processing means is further configured to: derive a subset of a CSI codebook; and transmit a subset indication of the subset of the CSI codebook to the wireless device, wherein the precoding vector is derived based on the index x and the subset of the CSI codebook.

Optionally, in any of the preceding aspects, another implementation of the aspect provides the network apparatus is further configured to perform any of the methods of the second aspect.

An eighth aspect relates to a network apparatus, comprising: a receiving means for receiving a channel state information (CSI) codebook and a reference signal; a transmitting means for reporting an index of a CSI codebook entry; and a processing means for: receiving the CSI codebook; receiving the reference signal from a base station; deriving an estimated channel according to the reference signal; selecting the CSI codebook entry from the CSI codebook based on the estimated channel and a selection criterion; and reporting the index of the CSI codebook entry to the base station.

Optionally, in any of the preceding aspects, another implementation of the aspect provides the CSI codebook is a first CSI codebook and the processing means is further configured to: receive a subset indication of a subset of the first CSI codebook; and derive a second CSI codebook from the first CSI codebook and the subset indication, wherein selecting a CSI codebook entry from the CSI codebook comprises selecting the CSI codebook entry from the second CSI codebook based on the estimated channel and a selection criterion.

Optionally, in any of the preceding aspects, another implementation of the aspect provides the network apparatus is further configured to perform any of the methods of the third aspect.

For the purpose of clarity, any one of the foregoing embodiments may be combined with any one or more of the other foregoing embodiments to create a new embodiment within the scope of the present disclosure.

These and other features, and the advantages thereof, will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example wireless communication system.

FIG. 2A illustrates physical layer channels and signals including Primary Synchronization Signal/Secondary Synchronization Signal (PSS/SSS), Physical Broadcast Channel (PBCH) and its associated Demodulation Reference Signal (DMRS).

FIG. 2B illustrates signals/channels that are multiplexed for more than one User Equipment (UE).

FIG. 2C illustrates examples of non-zero power (NZP) CSI-Reference Signals (CSI-RS) used for, e.g., channel estimation, beam management, and interference measurement, which are multiplexed with Physical Data Shared Channel (PDSCH) for one or more UEs.

FIG. 2D illustrates a resource grid.

FIG. 3A illustrates an example of a general form of autoencoder.

FIG. 3B illustrates an example of an autoencoder-based CSI compression Machine Learning (ML) model/system.

FIG. 3C illustrates an example of components/sub-models of the autoencoder-based CSI compression ML model/system of FIG. 3B.

FIG. 3D illustrates an example of vector quantization codebook learning by using outputs of a CSI encoder based on training samples.

FIG. 3E illustrates an example of a vector quantization codebook after a codebook learning procedure is completed.

FIG. 4A illustrates a procedure embodying general steps to obtain and use an artificial intelligence (AI)/ML (autoencoder) generated CSI codebook according to the disclosure.

FIG. 4B illustrates a set of performance results comparing distribution of squared generalized cosine similarity (SGCS) per feedback per subband for different methods for CSI reporting according to the disclosure.

FIG. 5 illustrates a procedure for a UE side according to the disclosure.

FIG. 6A illustrates a procedure for a base station (BS) side according to the disclosure.

FIG. 6B illustrates a procedure at a next generation (NG) Node B (gNB) upon receiving an index of a selected CSI codebook entry from a UE according to the disclosure.

FIG. 7 illustrates a method of a training phase of CSI compression model using samples with various ranks according to the disclosure.

FIG. 8 illustrates an example communication system according to the disclosure.

FIG. 9A illustrates an example ED according to the disclosure.

FIG. 9B illustrates an example base station according to the disclosure.

FIG. 10 is a block diagram of a computing system according to the disclosure.

FIG. 11 is a graph of performance numbers for Scalar Quantization.

FIG. 12 is a graph of performance/SGCS impact when using different code size and codebook size combinations.

FIG. 13 depicts example procedures of an AI/ML model training phase according to the disclosure.

FIG. 14 describes procedures performed during a model inference/testing phase according to the disclosure.

FIG. 15 is a Cumulative-Distribution-Function (CDF) comparison plot for 4 approaches to CSI reporting according to the disclosure.

FIG. 16 depicts a SGCS CDF comparison among different generalization cases according to the disclosure when the target scenario is urban macrocells (UMa).

FIG. 17 depicts the SGCS distribution comparison among different generalization cases according to the disclosure when the target scenario is urban microcells (UMi).

FIG. 18 depicts a Mean User Perceived Throughput (UPT) performance comparison between a baseline, i.e., 3GPP Release 16 (Rel-16) Type II codebook-based approach and an AI/ML based approach according to the disclosure.

FIG. 19 shows a 5% UPT performance comparison corresponding to FIG. 18.

FIG. 20 shows a SGCS performance comparison corresponding to FIG. 18.

FIG. 21 is a diagram of a network apparatus according to an embodiment of the disclosure.

FIG. 22 is a diagram of an apparatus configured to implement one or more of the methods described herein according to embodiments of the disclosure.

FIG. 23 depicts a system using an autoencoder and quantization according to an embodiment of the disclosure.

FIG. 24 illustrates a procedure for a UE side according to an embodiment of the disclosure.

FIG. 25 illustrates a procedure for a gNB side according to an embodiment of the disclosure.

FIG. 26 illustrates a procedure embodying general steps to obtain and use an artificial intelligence (AI)/ML (autoencoder) generated CSI codebook according to the disclosure.

### DETAILED DESCRIPTION

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

For MIMO transmission in wireless communication utilizing multiple transmit antennas at the transmitter side and multiple receive antennas at the receiver side, it is beneficial for the transmitter to obtain CSI of the channels between the transmitter and the receiver so that appropriate precoding can be performed for transmissions. For time division duplex (TDD) systems, due to channel reciprocity between downlink (DL) and uplink (UL) channels, a UL sounding reference signal (SRS) can be sent by the UE for the base station (e.g., gNB) to obtain DL CSI. For frequency division duplex (FDD) systems and TDD systems, where SRS capacity and/or related UE capability is lacking, the receiver (at the UE) measures DL reference signals (RS) to obtain DL CSI and reports the DL CSI to the transmitter (at the gNB).

In Third Generation Partnership Project (3GPP) Release 10, the channel state information reference signal (CSI-RS) is introduced. The CSI-RS is used by Release 10 User Equipment (UE) to measure the channel status, especially for multiple antennas implementations. Precoding matrix indicator (PMI), channel quality indicator (CQI), rank indicator (RI), and other feedback information may be based on the measurement of the CSI-RS by UEs implementing Release 10 and beyond. The CSI-RS in Release 10 may support up to 8 transmission antennas. The number of CSI-RS antenna ports may be 1, 2, 4, or 8. In 3GPP Release 13, beamformed or precoded CSI-RS is introduced, and a UE can be configured to receive one or more precoded CSI-RSs and report a CSI with the associated precoded CSI-RS resource index (CRI). In 5G New Radio (NR), 16 and 32 antenna ports in the CSI-RS are supported. It is expected that higher number of CSI-RS antenna ports (e.g., 64 and/or 128) will be supported in cellular technology implementing 5G and beyond to better support massive MIMO operation.

The PMI, as part of the CSI, is often generated by the receiver (e.g., UE) based on the measurement of the CSI-RS and a CSI codebook. In 5G NR, the CSI codebook is defined in standard specifications and is known at both the receiver (e.g., UE or electronic device (ED)) and the transmitter (e.g., gNB), and may comprise multiple entries, each of which is a precoding matrix or precoding vector as a special form of precoding matrix. The UE searches for an entry of the codebook that best matches the measured channel, according to the measurement of the CSI-RS. For example, the entry may be the one best matches the principal eigenvector(s) of the measured channel matrix. The UE may then report the index x of the best matched entry in the codebook as PMI in the CSI report sent to the gNB as well as RI and CQI associated with the reported PMI. In 5G NR, two types of CSI codebooks are defined: Type I codebook and Type II codebook. The Type I codebook utilizes less CSI feedback overhead than a Type II codebook but is mainly targeted at single user MIMO (SU-MIMO) operation. The Type II codebook gives finer spatial resolution and is mainly targeted at multi-user MIMO (MU-MIMO) operation, which can achieve higher spectral efficiency than SU-MIMO, especially in massive MIMO case, but at the price of much higher CSI feedback overhead.

A problem of CSI reporting is the associated overhead, especially in the case of massive MIMO where the number of antennas is large, as well as in the case of a wideband system, where CSI is reported for each subband in order to improve frequency selectivity demands. The number of bits for a CSI report can be up to a couple of hundred bits for good MIMO performance using Type II codebooks defined in 3GPP. Such overhead results in large amount of resources used for the CSI report and may also limit the coverage of the CSI report in physical uplink control channel (PUCCH) messages and/or physical uplink shared channel (PUSCH) messages.

To reduce the CSI report overhead, compression of the CSI for reporting utilizing AI/ML technologies is included in 3GPP Release 18 study item (SI) as a use case. Techniques of Machine Learning, and more specifically Deep Learning, may be leveraged to enhance existing physical layer communication functions. CSI compression techniques based on Deep Learning may also provide significant gains.

To address the high overhead in CSI feedback, an autoencoder-type approach may be used. An autoencoder may be implemented as a neural network that is trained to copy its input to its output. Such an autoencoder is trained in the model training process to compress the data while minimizing reconstruction error using collected training samples. For example, given an image of a handwritten digit, an autoencoder may first encode the image into a lower dimensional latent representation, then decode the latent representation back to an image.

One form of an autoencoder may include an encoder part and a decoder part. For reducing CSI feedback overhead, the “encoder” first learns a transformation or mapping from original channel matrices (or eigenvectors of the channel matrices) to compressed representations, i.e., translating the extracted feature maps or codewords through training data. The algorithm is agnostic to domain knowledge on channel distribution and instead directly learns to effectively use the channel structure from training data. The “decoder”, then learns a fitting inverse transformation from codewords to original channel matrices (or eigenvectors of the channel matrices) from the same set of training samples. Once trained using sufficient samples, the autoencoder model reduces both CSI feedback overhead and time complexity significantly during inference phase.

As such, AI/ML technologies such as an auto-encoder may be utilized to compress CSI feedback. In addition, a look-up table (LUT) may be generated for vector quantization of the encoder outputs and to serve as a codebook for CSI reporting. Overhead reduction of as much as 80-90% may be achieved while providing comparable performance to that of traditional method such as Type-II codebook.

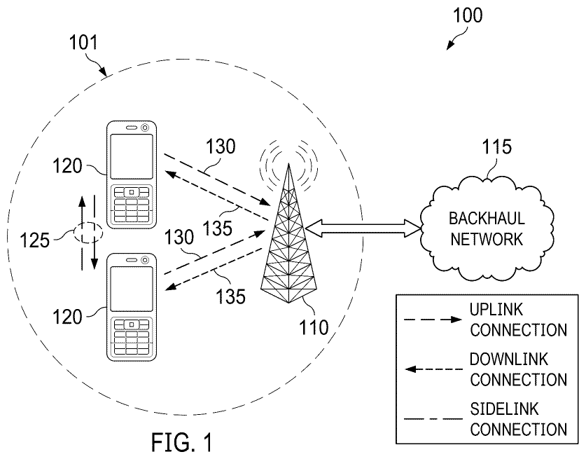

FIG. 1 illustrates an example wireless communication system 100. The communication system 100 includes a base station 110 with coverage area 101. The base station 110 serves a plurality of UEs, including UEs 120. Transmissions from the base station 110 to a UE is referred to as a downlink (DL) transmission and occurs over a downlink channel (shown in FIG. 1 as a dotted arrowed line 135), while transmissions from a UE to the base station 110 is referred to as an uplink (UL) transmission and occurs over an uplink channel (shown in FIG. 1 as a dashed arrowed line 130). Data carried over the uplink/downlink connections may include data communicated between the UEs 120, as well as data communicated to/from a remote-end (not shown) by way of a backhaul network 115. Example uplink channels and signals include physical uplink shared channel (PUSCH), physical uplink control channel (PUCCH), an uplink sounding reference signal (SRS), and a physical random access channel (PRACH). Services may be provided to the plurality of UEs by service providers connected to the base station 110 through the backhaul network 115, such as the Internet. The wireless communication system 100 may include multiple base stations 110.

A communication system may have several operating modes. In a cellular operating mode, communications to and from the plurality of UEs go through the base station 110, while in device to device communications mode, such as proximity services (ProSe) operating mode, for example, direct communication (via sidelinks 125) between UEs is possible. As used herein, the term “base station” refers to any component (or collection of components) configured to provide wireless access to a network. Base stations may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, access nodes, access points (APs), transmission points (TPs), transmission-reception points (TRPs), cells, carriers, macro cells, femtocells, pico cells, relays, customer premises equipment (CPE), the network side, the network, and so on. In the present disclosure, the terms “base station” and “gNB” are used interchangeably unless otherwise specified. As used herein, the term “UE” refers to any component (or collection of components) capable of establishing a wireless connection with a base station. UEs may also be commonly referred to as mobile stations, mobile devices, mobiles, terminals, user terminals, users, subscribers, stations, communication devices, CPEs, relays, Integrated Access and Backhaul (IAB) relays, electronic devices, and the like. It is noted that when relaying is used (based on relays, picos, CPEs, and so on), especially multi-hop relaying, the boundary between a controller and a node controlled by the controller may become blurry, and a dual node (e.g., either the controller or the node controlled by the controller) deployment where a first node that provides configuration or control information to a second node is considered to be the controller. Likewise, the concept of UL and DL transmissions can be extended as well.

A cell may include one or more bandwidth parts (BWPs) for UL or DL allocated for a UE. Each BWP may have its own BWP-specific numerology and configuration, such as the BWP's bandwidth and subcarrier spacing. It is noted that not all BWPs may be active at the same time for the UE. A cell may correspond to one carrier, and in some cases, multiple carriers. Often, one cell (a primary cell (PCell) or a secondary cell (SCell), for example) is a component carrier (a primary component carrier (PCC) or a secondary CC (SCC), for example). For some cells, each cell may include multiple carriers in UL, one carrier may be referred to as an UL carrier or non-supplementary UL (non-SUL, or simply UL) carrier, which has an associated DL, and other carriers may be called supplementary UL (SUL) carriers, which do not have an associated DL. A cell, or a carrier, may be configured with slot or subframe formats comprising DL and UL symbols, and that cell or carrier may be seen as operating in a time division duplexed (TDD) mode. Often, for unpaired spectrum, the cells or carriers are in TDD mode, and for paired spectrum, the cells or carrier are in a frequency division duplexed (FDD) mode. A transmission time interval (TTI) may correspond to a subframe (in LTE) or a slot (in NR). Access nodes may provide wireless access in accordance with one or more wireless communication protocols, e.g., long term evolution (LTE), LTE advanced (LTE-A), 5G, 5G LTE, 5G NR, future 5G NR releases, 6G, High Speed Packet Access (HSPA), Wi-Fi 802.11a/b/g/n/ac/ax/be, etc. While communication systems may employ multiple access nodes (or base stations) capable of communicating with a number of UEs, only one access node, and two UEs are illustrated in FIG. 1 for simplicity.

A way to increase the network resources is to utilize more usable spectrum resources, which include not only the licensed spectrum resources of the same type as the macro, but also the licensed spectrum resources of different type from the macro (e.g., the macro is a FDD cell but a small cell may use both FDD and TDD carriers), as well as unlicensed spectrum resources and shared-licensed spectrums. Some of the spectrum resources lie in high-frequency bands, such as 6 GHz to 60 GHz. The unlicensed spectrums may be used by generally any user, often subject to regulatory requirements. The shared-licensed spectrums are also not exclusive for an operator to use. Often, the unlicensed spectrums are not used by cellular networks because it is generally difficult to ensure quality of service (QoS) levels on unlicensed spectrums. Operating on the unlicensed spectrums mainly includes wireless local area networks (WLAN), e.g., the Wi-Fi networks. Because the licensed spectrum is generally scarce and expensive, utilizing the unlicensed spectrum by the cellular operator may be considered. Note that on high-frequency bands and unlicensed/shared-licensed bands, TDD is often used and hence the channel reciprocity can be exploited for the communications.

In some embodiments, a gNB controls one or more cells. Multiple remote radio units may be connected to the same base band unit of the gNB (e.g., by fiber cable), and the latency between base band unit and remote radio unit may be quite small. As a result, a single base band unit can process the coordinated transmission/reception of multiple cells. For example, the gNB may coordinate the transmissions of multiple cells to a UE, which is called coordinated multiple point (CoMP) or multi-TRP (mTRP, M-TRP) transmission. The gNB may also coordinate the reception of multiple cells from a UE, which is called CoMP or M-TRP reception. In this case, the backhaul link between these cells with the same gNB is a fast backhaul and the scheduling of data transmitted in different cells for the UE can be coordinated in the same gNB. The backhaul connections may also be ones with longer latency and lower transmission rates.

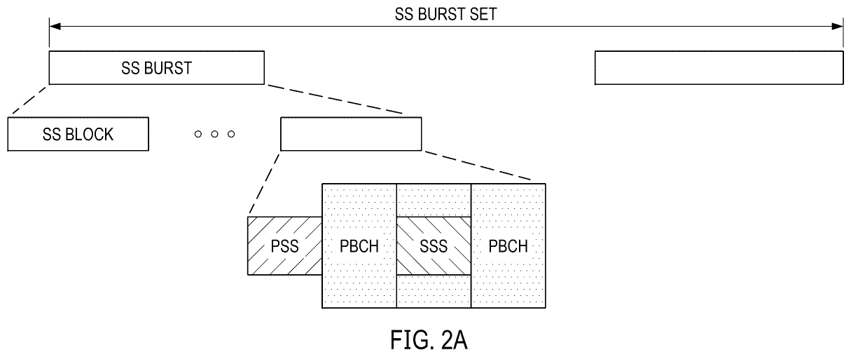

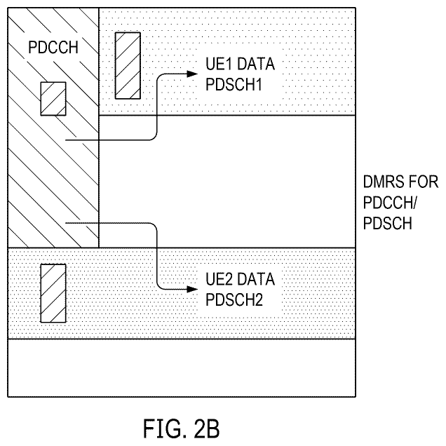

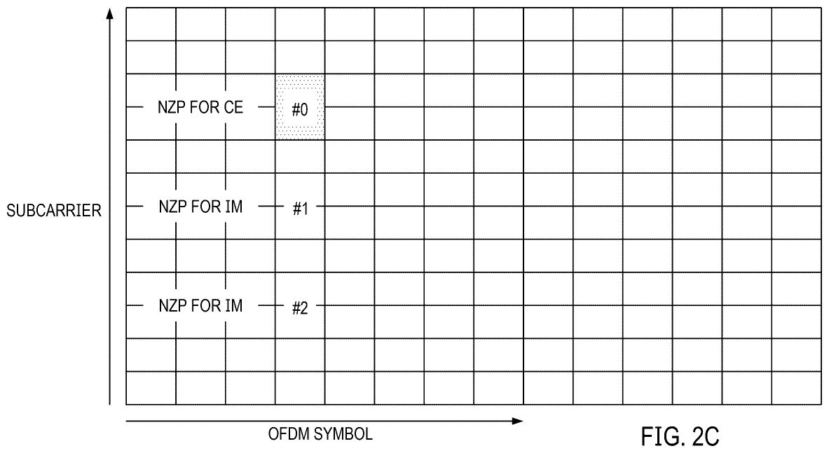

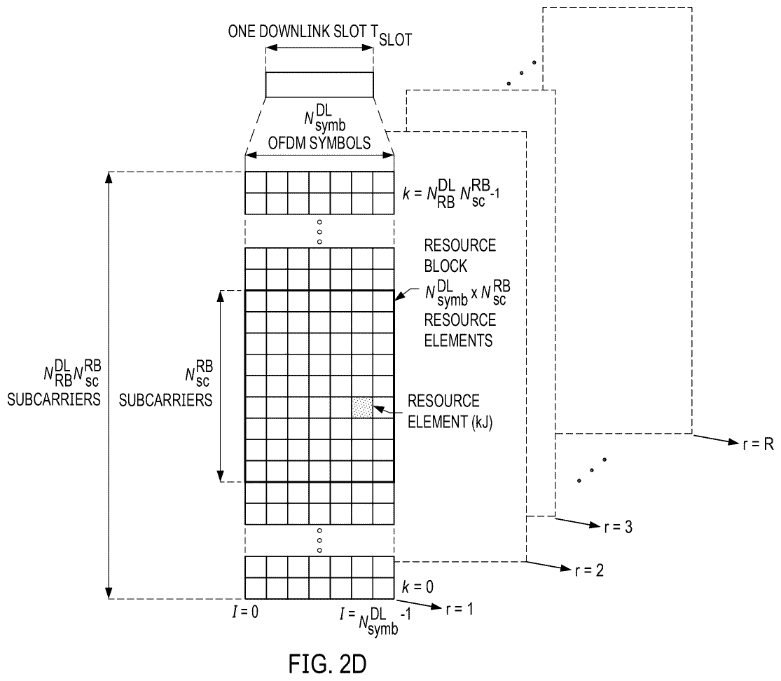

Physical layer channels and signals include PSS/SSS, PBCH and its associated DMRS (see, e.g., FIG. 2A, in which the Synchronization Signal (SS) bursts are embedded, i.e., multiplexed with PBCH around them), PDSCH and its associated DMRS, and phase tracking reference signal (PT-RS), Physical Downlink Control Channel (PDCCH) and its associated DMRS (see, e.g., FIG. 2B where some such signals/channels are multiplexed for more than one UE), and CSI-RS which further include signals/channels used, for CSI acquisition, for beam management, and for tracking (see FIG. 2C for examples of NZP CSI-RS used for, e.g., channel estimation, beam management, and interference measurement, which are multiplexed with PDSCH for one or more UEs). The CSI-RS for tracking is also called a tracking reference signal (TRS).

FIG. 2D illustrates a resource grid based on OFDM for DL (a similar resource grid exists for UL). Each resource unit in the resource grid is uniquely identified by (r, k, 1). The first index r is an index in the spatial domain such as the antenna port, ranging from 1 to R (or 0 to R−1). The second index k is an index in the frequency domain for the subcarrier, ranging from 0 to

$${N}_{R B}^{D L} {N}_{S C}^{R B} - 1 , where {N}_{S C}^{R B} = 12 ,$$

that is, 12 subcarriers form the frequency resource for a resource block (RB), and there can be

$${N}_{R B}^{D L}$$

resource blocks configured for a BWP or a carrier. The third index l is in the time domain for the OFDM symbol, ranging from 0 to

$${N}_{s y m b}^{D L} - 1 ,$$

where 14 OFDM symbols form a slot, and a number of slots form a radio frame. A subcarrier and an OFDM symbol determine a resource element (RE). The numbering may depend on a subcarrier spacing index μ. Though this figure is primarily for OFDM based designs, the embodiments in this disclosure can apply not only to OFDM based designs but also to other waveform-based designs.

For massive MIMO communication, CSI information is useful for efficient utilization of the spectrum to achieve high data rate and good spectral efficiency. CSI information can be derived via measuring SRS at the transmitter (e.g., gNB) side and used for DL transmission when reciprocity can be assumed between the two directions of the channels (i.e., downlink and uplink). CSI can also be estimated via measuring CSI-RS at the receiver (e.g., UE) side and reported to the transmitter (e.g., gNB) side.

Channel reciprocity should only be assumed for TDD system. Even in a TDD system, it is often the case that UE does not have the capability to sound all the carriers frequently and effectively enough to obtain CSI. SRS switching is specified in 3GPP LTE and NR but it is not without issues and difficulties in real deployments, mostly due to UE capability and complication of suspending other transmissions and relatively long delays from switching between carriers.

For CSI acquisition for MIMO communication between two or more wireless communication nodes (or wireless devices), CSI-RS of several antenna ports is transmitted by a first wireless node (e.g., a base station or a gNB of a 5G NR network). Each antenna port of the CSI-RS corresponds to a subset of transmitting antenna elements of the wireless node. A second wireless node measures the CSI-RS and estimates the CSI between the first and the second wireless nodes. In an embodiment, CSI-RS of N antenna ports are transmitted by the first wireless node and received by the second wireless node with M receive antennas, and the relevant bandwidth of the CSI-RS or of the corresponding BWP has K sub-carriers. The CSI between the two wireless nodes is for each pair of transmitting antenna port and the receiving antenna and for each sub-carrier. Therefore, the dimension of the CSI is of N by M by K, and each element of this CSI tensor of N by M by K dimension is a complex value. Alternatively, the CSI-RS bandwidth is divided into L subbands where each subband comprises a few sub-carriers or RBs. A channel covariance matrix can be estimated for each subband. And R principal eigenvectors (where each eigenvector is a 1 by N vector) can be derived from the channel covariance matrix for each subband. The R principal eigenvectors of the L subbands are also a representative CSI of the channel between the two wireless devices and its dimension is N by R by L.

CSI reporting from the receiver side generally has high overhead especially when the number of antennas is large (as in the case of massive MIMO), and when carrier bandwidth is wide where the channel becomes frequency selective, and the CSI needs to be reported for multiple subbands. For a typical massive MIMO system, CSI report overhead is in the range of tens to a few hundred bits, using the Type II codebooks defined in 3GPP. Considering the CSI reports need to be sent quite frequently, it will take a lot of radio resources.

AI/ML has recently been researched to compress CSI for reporting. An autoencoder is a commonly tried approach for this use case. Moderate gain of overhead reduction or performance (accuracy) can be achieved but generalization and robustness of the scheme is still not satisfying. In addition, when trying to achieve very low overhead of CSI reporting, the performance degrades significantly.

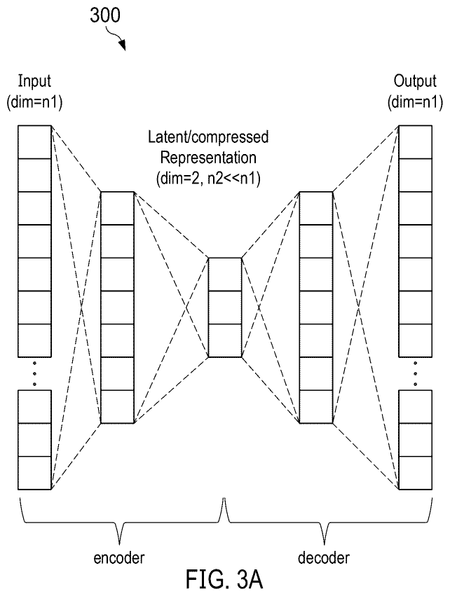

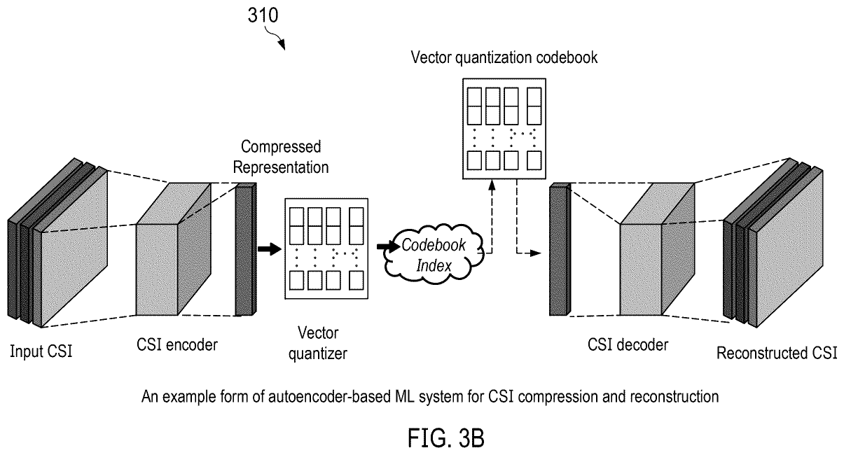

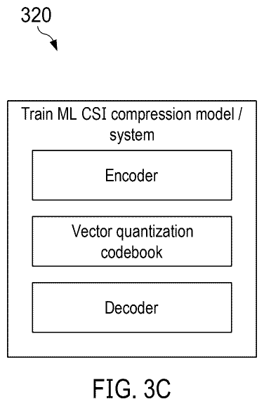

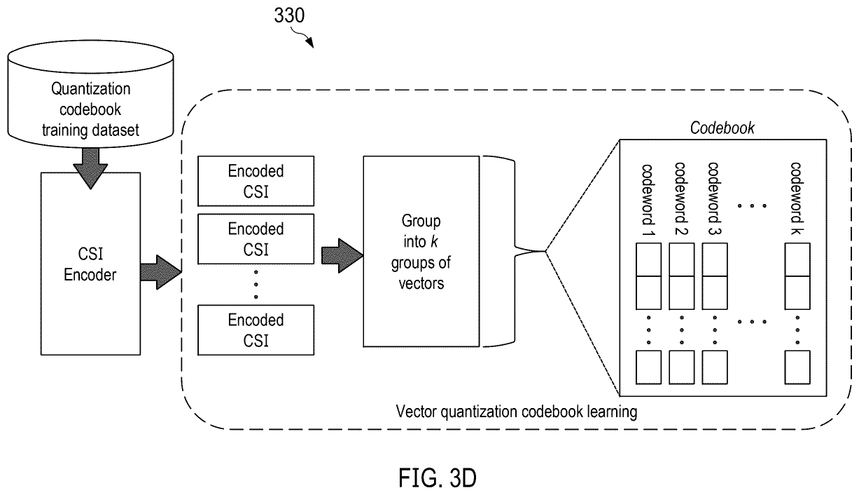

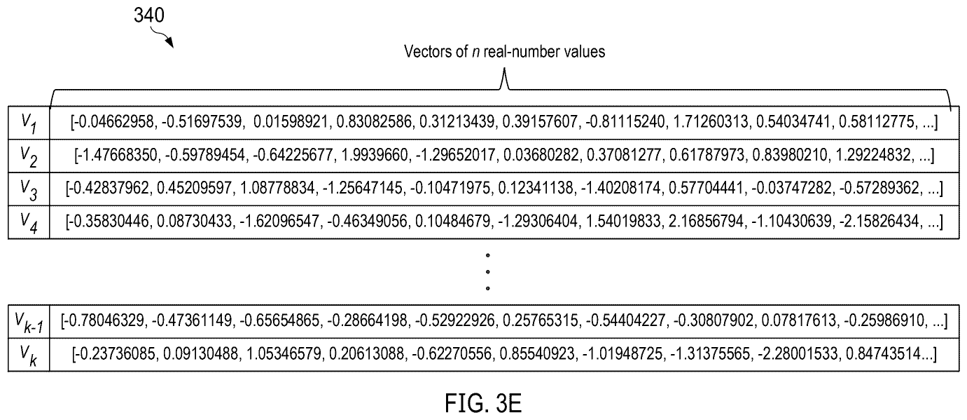

FIG. 3A illustrates an example of a general form of autoencoder 300. A typical autoencoder has two main parts: an encoder that maps the input to a compressed representation with much lower dimension/size than that of in the input, and a decoder that reconstructs the input from the compressed representation. An optimal autoencoder would perform as close to perfect reconstruction as possible using the training dataset.

FIG. 3B illustrates an example of an autoencoder-based CSI compression ML model/system (or autoencoder ML model) 310 that includes a CSI encoder, a vector quantizer and a vector quantization codebook derived from the vector quantizer and a CSI decoder. A ML-based CSI feedback compression and reconstruction includes at least a CSI encoder which learns a compressed or latent feature presentation of the CSI input(s), e.g., channel matrices or eigenvectors of the channel matrices based on the training dataset, and a CSI decoder which learns to reconstruct/recover the original CSI input(s) (channel matrices or eigenvectors of the channel matrices) from the compressed representation based on the training dataset.

An example of CSI encoder may include a few convolutional neural network layers to learn latent representation from the CSI inputs, followed by few fully connected neural network layers to further reduce the dimension/size and generate the final compressed representation, e.g., a vector with real-number values. A corresponding example of a CSI decoder may contain a few fully connected layers first to recover the feature maps with desired dimension/size from the compressed representation, i.e., output of the CSI encoder, followed by a few convolutional neural network layers to reconstruct the original CSI input from the recovered feature maps.

Another example of a CSI encoder may contain only fully connected neural network layers by first flattening the CSI input into one dimension, then compresses the dimension/size of the flattened CSI input to a low dimensional feature representation directly, e.g., a vector with real-number values. A corresponding example of a CSI decoder may also contain only fully connected neural network layers which gradually expands the dimension/size of the compressed representation and learns to reconstruct the original CSI input as close as possible then reshapes the final output to the desired shape as the original CSI input. There are other ML model architectures that can be leveraged for the CSI compression ML model (or system), such as Residual-based architecture and Attention-based architecture.

FIG. 3C illustrates an example of components/sub-models 320 of the autoencoder-based CSI compression ML model/system 310. The components/sub-models 320 may include an encoder, a quantizer and a decoder models, parts, or modules. The three models or modules may be obtained via various approaches.

One example approach is to train the encoder, the quantizer and the decoder in an end-to-end manner, i.e., all three models or modules are trained in one joint session. Once the training process finishes, the encoder, the quantizer and the decoder may be separated from the overall combined model and the three models may then be used in an independent way. In this approach, the quantization codebook is a byproduct of the quantizer from the end-to-end training procedure using the training samples.

Another example approach is to first train only the autoencoder (including the encoder and the decoder models or parts). Once the training is finished, the encoder model and the decoder model may be separated from the autoencoder model, then the quantization codebook may be learned in a separate step using the encoded output of the original training samples or using the encoded output of a different set of samples.

FIG. 3D illustrates an example of vector quantization codebook learning 330 by using the outputs of the CSI encoder based on training samples. A CSI encoder encodes each training sample into a compressed representation with much lower dimension/size than that of the CSI input(s) (e.g., channel matrices or eigenvectors of the channel matrices), generating a large set of representations, where each representation is a vector with real-number values. A vector quantizer groups the large set of representations/vectors into a smaller/finite set of groups, e.g., k groups as shown in FIG. 3D. In some embodiments, each group is represented by its centroid vector. After the learning is finished, a vector quantization codebook is generated, which contains k entries, and each entry comprises a vector with dimension/size that is the same as the dimension/size of the CSI encoder output. FIG. 3E illustrates an example of a vector quantization codebook 340 after the codebook learning procedure is completed. The vector quantization codebook 340 includes k entries/vectors, and each entry/vector includes n real-number values, where n=a dimension/size of the CSI encoder output.

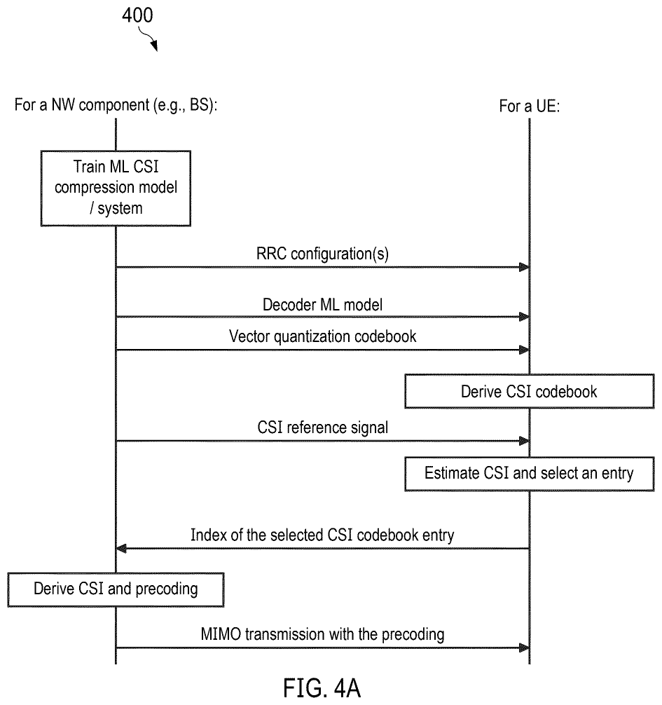

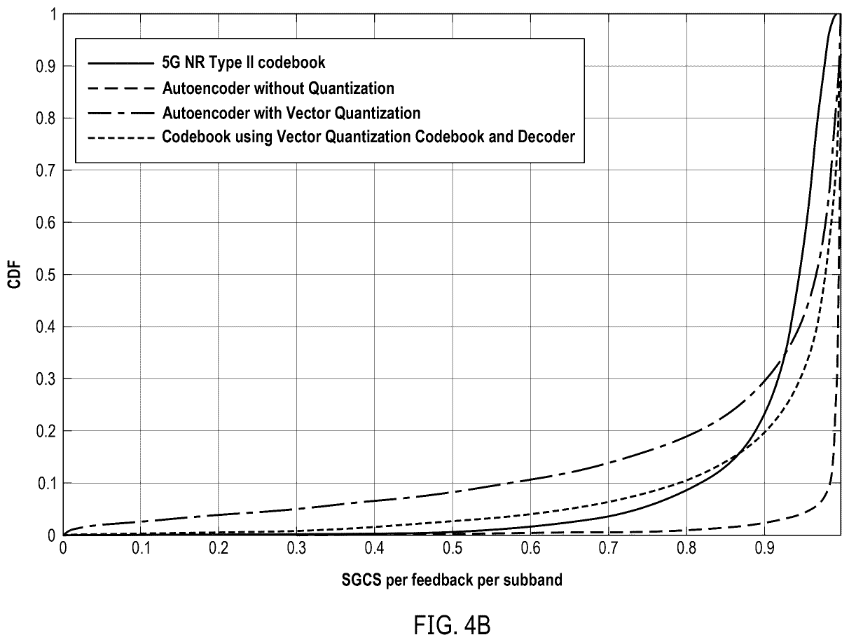

FIG. 4A illustrates a procedure 400 embodying general steps to obtain and use an AI/ML (autoencoder) generated CSI codebook according to the disclosure. A ML CSI compression Model (including a CSI encoder part, a CSI decoder part, and a vector quantizer) is trained (and tested) using a CSI dataset. The CSI encoder part extracts features from high dimensional CSI data and maps them into a lower dimensional vector, e.g., from input with dimension/size of (# antenna ports×# layers×# subbands) to a vector with dimension/size of n where n<<(# antenna ports×# layers×# subbands) for each training sample, in which each element (of n) is represented in real number space. The vector quantizer encodes each output of the CSI encoder part from a multidimensional vector space into a finite set of values from a discrete subspace of lower dimension and generates a quantization codebook based on the training dataset. The CSI decoder part first recovers an encoded vector in real-number space using the quantization codebook then reconstructs the CSI with the original input dimension. As an embodiment, the CSI is a tensor of complex values with a dimension of (# antenna ports×# layers×# subbands). In the case of 32 antenna ports, 2 layers, and 20 subbands, the dimension/size is 32×2×20×2=2560. The output of the encoder model for each sample can be much smaller, for example, a vector with dimension/size of size n, where n=64 or 128.

In a variation, a CSI compression ML model (or system) consisting of only the CSI encoder part and the CSI decoder part can be trained in advance (without the vector quantizer). A quantization codebook for vector quantization may be learned/obtained in a separate step. For example, by using a clustering method on the encoder outputs of a CSI dataset. This CSI dataset can be the same as (or a subset of) the CSI dataset used for encoder and decoder training. Alternatively, this CSI dataset can be a different CSI dataset, for example, for a specific scenario, or a specific gNB. The vector quantization codebook size can vary depending on the scenario. For very small CSI report/feedback overhead, for example, of 10, 11, 12, or 13 bits, the vector quantization codebook will have 1024, 2048, 4096, or 8192 entries, respectively, and the dimension/size of each entry is the dimension/size of the encoder output, for example, each entry is a vector of 128 real-number values.

After the training is finished, the decoder part of the CSI compression ML model, which is a sub-model of the autoencoder defined by its model architecture and parameter weights, and the vector quantization codebook are delivered to the UE. Corresponding configuration message may be sent to the UE, for example via Radio Resource Control (RRC) signaling, to inform parameters of the decoder and the vector quantization codebook. As an embodiment, the UE derives a CSI codebook by using the vector quantization codebook as input to the decoder part of the CSI compression ML model. An entry of the CSI codebook is the output of the decoder part of the CSI compression when an entry of the vector quantization codebook is used as the input of the decoder part of the CSI compression. As such, the number of entries of the CSI codebook is the same as that of the vector quantization codebook. Alternatively, the CSI codebook can be directly delivered to the UE. However, the communication overhead of sending CSI codebook directly will be much larger as the dimension (and size) of a CSI codebook entry (which is the same as the CSI, i.e., the input to the encoder) is much larger than that of a vector quantization codebook entry (i.e., the output of the encoder). Another alternative is that the decoder part of the CSI compression ML model and the vector quantization codebook can be sent to the UE separately. For example, a decoder part of the CSI compression ML model can be trained using a large amount of CSI data for various scenarios and sent to the UE only once. The vector quantization codebook can be trained/learned with dataset for a specific scenario or a specific gNB in order to have an even smaller size with good performance for that specific scenario or gNB. The vector quantization codebook can then be updated and delivered to the UE whenever needed to have better tradeoff between performance and overhead.

As an embodiment, the CSI compression ML Model (including the CSI encoder part, the CSI decoder part, and the vector quantizer) can be trained in advance, for example at a network controller, a server, or in a factory. The CSI decoder and the vector quantization codebook are then delivered to the wireless communication devices such as a gNB for 5G NR or a 6G base station and to a UE.

In yet another embodiment, a CSI compression ML model consisting of only the CSI encoder part and the CSI decoder part can be trained in advance (without the vector quantizer), for example at a server or in a factory. The CSI encoder and the CSI decoder are then delivered to a wireless communication node such as a gNB for 5G NR or a 6G network controller or base station. A quantization codebook for vector quantization can be learned/obtained at the wireless communication node, for example by using a clustering method on the encoder outputs of a CSI dataset. This CSI dataset can be a different CSI dataset from that used for encoder and decoder training, for example, this CSI dataset may be for a specific scenario, or a specific gNB. The vector quantization codebook size can vary depending on the scenario. For very small CSI report/feedback overhead, for example, of 10, 11, 12, or 13 bits, the vector quantization codebook will have 1024, 2048, 4096, or 8192 entries, respectively, and the dimension/size of each entry is the dimension/size of the encoder output, for example, each entry is a vector of 128 real-number values. The CSI decoder and the vector quantization codebook are then transmitted (together or separately) to another wireless communication node, such as a UE. The vector quantization codebook can be updated more frequently to the UE and its dimension/size may vary. Corresponding configuration message may be sent to the UE, for example via Radio Resource Control (RRC) signaling, to inform parameters of the decoder and the vector quantization codebook. As yet another embodiment, the vector quantization codebook can be trained in a different network controller and then delivered to a gNB or a base station which then sends the vector quantization codebook to the UE.

Returning to the method 400, a gNB or a base station transmits a reference signal (for example, a CSI-RS) to the UE. The UE receives and measures the reference signal from the gNB to estimate channel state information and then selects an entry from the CSI codebook based on the estimated CSI and a selection criterion. The criterion may be, for example, maximizing the received SINR (or CQI), maximizing the data rate of the transmission (or MCS), maximizing generalized cosine similarity (GCS) or squared generalized cosine similarity (SGCS) between the estimated CSI and the codebook entries, or other suitable criteria. Exhaustive search can be performed to select a best entry of the criterion. This is feasible when the codebook size is relatively small. When the codebook size is large—for example, its representation is larger than 20 bits (or more than 1 million entries)—methods may be used to reduce searching complexity.

As an embodiment, a different CSI compression ML model and vector quantization codebook can be trained/learned for different configurations, e.g., different Tx antennas or panel settings, or a unified CSI compression ML model and vector quantization codebook can be trained/learned to work for various configurations by leveraging some adaptation mechanisms, if desired, depending on the needs and performance vs. storage overhead considerations.

Returning to the method 400, the UE reports the index x of the selected vector quantization codebook entry to the gNB. The report of the index may be sent in PUCCH or in PUSCH to the gNB. In case the rank is larger than 1, multiple indices may be selected and reported where each index of the multiple indices corresponds to one layer of principal eigenvectors for the subbands of the CSI. Rank indicator (i.e., number of layers) and CQI(s) may be reported also to the gNB.

In addition, a measure (or quantitative value) of CSI report accuracy, for example, GCS (or SGCS) between the estimated CSI and the reported CSI can be reported together with the index to facilitate a better use of the CSI report in the gNB. One example is to set a threshold of GCS (or SGCS) value and report 1 when GCS (or SGCS) of the reported CSI is no less than the threshold and report 0 otherwise. Multiple levels of values can also be reported. For example, with 2 bits, 4 quantitative values or levels can be reported. In the case of low CSI report accuracy, the gNB can perform scheduling and MIMO/precoding differently, for example by not pairing with other UEs for MU-MIMO transmission to avoid interfering each other.

As an alternative, a quantitative value of GCS (or SGCS) for each subband may be reported as a metric of CSI report accuracy. Alternatively, in the case of low CSI report accuracy when using the CSI codebook, the UE may report CSI using a different approach. For example, a wideband CSI may be selected and reported using a wideband codebook (e.g., a NR Type I codebook or an AI/ML generated codebook for wideband report). As an embodiment, some entries of the CSI codebook are reserved for a wideband codebook as fall back in case that the subband selective CSI codebook yields low CSI accuracy. As a different embodiment, a combined CSI codebook which comprises a subset of entries from a subband selective codebook and another subset of entries from a different codebook, for example wideband codebook, can be used. At the same time, the need for CSI compression model (or just the quantization codebook) retraining can be assessed to improve CSI report accuracy.

Returning to the method 400, the gNB recovers the CSI using the quantization codebook and the decoder or using the CSI codebook derived from them and performs precoding and MIMO transmission. The gNB receives the index x of the CSI codebook from the UE. The gNB can obtain the vector quantization codebook entry of the index and then pass it through the decoder to generate an output as the reported CSI. Alternatively, the gNB may derive a CSI codebook by passing the vector quantization codebook through the decoder part of the CSI compression ML model. After receiving the index of the CSI codebook from the UE, the gNB can obtain the CSI codebook entry as the reported CSI. In cases where rank is larger than 1, multiple indices may be received by the gNB from the UE. The gNB obtains a CSI codebook entry for each index as the reported CSI for each layer. The gNB may also receive a measure of CSI report accuracy, for example, quantitative GCS (or SGCS) and perform precoding and MIMO scheduling accordingly. Alternatively, a combined CSI codebook which comprises a subset of entries from a subband selective codebook and another subset of entries from a different codebook, for example wideband codebook, can be used. And CSI codebook entry is selected by the gNB according to the received index of the CSI codebook from the UE. The CSI codebook used by the gNB and the CSI codebook used by the UE are the same.

Returning to the method 400, based on the CSI reported from the UE, the gNB derives the precoding vector(s) for transmissions of physical layer channel such as PDSCH, PDCCH and the associated DMRS or reference signal such as a CSI-RS and etc. As an example, when CSI reported is the channel matrices, eigenvector(s) may be derived from the CSI reported. Alternatively, the CSI reported is the eigenvector(s) of the channel matrices. The gNB may derive the precoding vector(s) based on the channel eigenvector(s). The gNB may further adjust the precoding vector(s) according to other factors, for example, the CSI of another UE or other UE(s) paired for transmission over the same time and frequency radio resources such as a resource element or a RB for 5G NR or a 5G networks. The gNB then transmits the physical layer channel or signal by applying the precoding vector(s) over the involved transmitting antenna ports.

FIG. 4B illustrates a set of performance results comparing distribution of SGCS per feedback per subband for different methods for CSI reporting according to the disclosure. Four methods are compared. The first method (illustrated as solid line) is using Type II codebook feedback defined for 5G NR system. The second method (illustrated as dash line) is using a CSI compression ML Model without vector quantizer (including a CSI encoder part and a CSI decoder part) where the UE is using the CSI encoder to generate CSI report without quantization. The third method (illustrated as dash dotted line) is using a CSI compression ML Model with quantization (including a CSI encoder part, a CSI decoder part, and a vector quantizer) where the UE is using the CSI encoder and the vector quantization to generate CSI report. The fourth method (illustrated as dotted line) is using a CSI compression ML Model with quantization (including a CSI encoder part, a CSI decoder part, and a vector quantizer) where the UE derives a CSI codebook using the vector quantization codebook and the CSI decoder and then selects a CSI codebook entry maximizing SGCS to generate CSI report.

The comparison of these methods shows that the fourth method (where CSI codebook is derived using the vector quantization codebook and the CSI decoder for CSI report generation) outperforms significantly the third method (where CSI encoder and vector quantizer is used to generate CSI report). As shown in FIG. 4B, the CDF distribution of method 4 is always to the right of the CDF distribution of method 3 which means method 4 statistically has higher SGCS than method 3. It also shows that the fourth method can have similar or even better performance comparing the first method based on 5G NR Type II codebook which has much higher overhead. The mean values of SGCS for these 4 methods shown in FIG. 4B are 0.9155, 0.9880, 0.8700, 0.9266, respectively. System level performance also shows the same trends as shown here. Note that these 4 methods as illustrated in FIG. 4B also have different CSI report overhead. The number of bits per report for these 4 methods are 242 (using a specific configuration), 4096 (for a length 128 vector and 32 bits per element), 13, and 13, respectively. The fact that method 4 can achieve better CSI report accuracy than method 1 (5G NR Type II codebook) using much smaller number of bits per report, 13 bits versus 242 bits, makes it more significant.

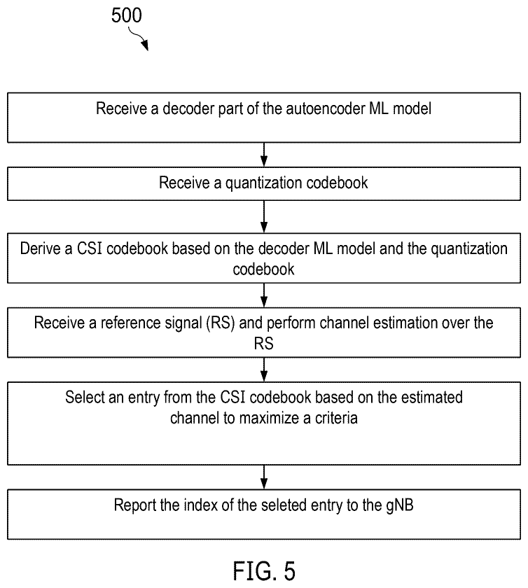

FIG. 5 illustrates a procedure 500 for a UE side according to the disclosure. As an embodiment, the UE receives the decoder part of a CSI compression ML model from a first network controller. Alternatively, the UE may receive the decoder part of the CSI compression ML model from a network server, a base station, or a device producer. The UE receives a vector quantization codebook associated with the CSI decoder of the CSI compression ML model from a second network controller. The second network controller can be the same as the first network controller or it can be different from the first network controller. Alternatively, the UE may receive the vector quantization codebook associated with the CSI decoder of the CSI compression ML model from the network server, base station, or the device producer.

As an embodiment, the UE derives a CSI codebook by passing the vector quantization codebook through the decoder part of the CSI compression ML model. An entry of the CSI codebook is the output of the decoder part of the CSI compression when an entry of the vector quantization codebook is used as the input of the decoder part of the CSI compression. Therefore, the number of entries of the CSI codebook is the same as that of the vector quantization codebook. As an embodiment, the UE may receive the CSI codebook directly from the first network controller, which may derive the CSI codebook based on the decoder part (or model) of the CSI compression ML system and the vector quantization codebook. However, the overhead of sending CSI codebook directly will be much larger as the dimension (and size) of a CSI codebook entry (which is the same as the CSI, i.e. the input to the encoder) is much larger than that of a vector quantization codebook entry (i.e., the output of the encoder). Another alternative is that the UE receives the decoder part of the CSI compression ML model and the vector quantization codebook separately. For example, a decoder part of the CSI compression ML model can be trained using a large amount of CSI data for various scenarios and the UE only receives once or less frequently. The vector quantization codebook can be trained/learned with data for a specific scenario or a specific gNB in order to have even smaller size with good performance for that specific scenario or gNB. The UE then receives the vector quantization updates whenever needed to have better tradeoff between performance and overhead.

As an embodiment, a CSI compression ML Model (including a CSI encoder part, a CSI decoder part, and a vector quantizer) can be trained in advance, for example at a server or in a factory. The CSI decoder and the vector quantization codebook are then delivered to the wireless communication devices such as a gNB for 5G NR or a 6G base station and a UE.

As yet another embodiment, a CSI compression ML model consisting of only the CSI encoder part and the CSI decoder part can be a trained in advance (without the vector quantizer), for example at a server or in a factory. The CSI encoder and the CSI decoder are then delivered to a wireless communication node such as a gNB for 5G NR or a 6G network controller or base station. A quantization codebook for vector quantization may be learned/obtained at the wireless communication node. For example, using clustering method on the encoder outputs of a CSI dataset. This CSI dataset can be a different CSI dataset from that used for encoder and decoder training, for example, the CSI dataset may be for a specific scenario, or a specific gNB. The vector quantization codebook size can vary depending on the scenario. For very small CSI report/feedback overhead, for example, of 10, 11, 12, or 13 bits, the vector quantization codebook will have 1024, 2048, 4096, or 8192 entries, respectively, and the size of each entry is the size of the encoder output, for example, each entry is a vector of 128 real-number values. The UE then receives the CSI decoder and the vector quantization codebook (together or separately) from the wireless communication node. The vector quantization codebook can be updated more frequently to the UE and its size may vary. Corresponding configuration message may be received by the UE, for example via RRC signaling, to inform parameters of the decoder and the vector quantization codebook. As yet another embodiment, the vector quantization codebook can be trained in a different network controller and then delivered to a gNB or a base station. Then the UE receives the vector quantization codebook from the gNB.

As an embodiment, the UE receives and measures the reference signal (for example, CSI-RS) from the gNB to estimate channel state information and then selects an entry from the CSI codebook based on the estimated CSI and a selection criterion. The criterion may be, for example, maximizing the received SINR (or CQI), maximizing the data rate of the transmission (or MCS), maximizing GCS (or SGCS) between the estimated CSI and the codebook entries, etc. Exhaustive search can be performed to select the best entry of the criterion. This is feasible when the codebook size is relatively small. When the codebook size is large, for example, its representation is larger than 20 bits (or more than 1 million entries), methods may be used to reduce searching complexity.

The UE reports the index x of the selected entry to the gNB. The report of the index may be sent in PUCCH or in PUSCH to the gNB. In case of rank larger than 1, multiple indices may be selected and reported where each index of the multiple indices corresponds to one layer of principal eigenvectors for the subbands of the CSI. Rank indicator (i.e., number of layers) and CQI(s) may be reported also to the gNB.

In addition, a measure of CSI report accuracy, for example, GCS (or SGCS) between the estimated CSI and the reported CSI can be reported together with the index to facilitate a better use of the CSI report in the gNB. One example is to set a threshold of GCS (or SGCS) value and report 1 when GCS (or SGCS) of the reported CSI is no less than the threshold and report 0 otherwise. Multiple levels of values can also be reported. For example, with 2 bits, 4 quantitative values or levels can be reported. In the case of low CSI report accuracy, gNB can perform scheduling and MIMO/precoding differently, for example by not pairing with other UEs for MU-MIMO transmission to avoid interfering each other. As an alternative, quantitative GCS (or SGCS) for each subband may be reported as a metric of CSI report accuracy.

Alternatively, in the case of low CSI report accuracy when using the CSI codebook, the UE may report CSI using a different approach. For example, a wideband CSI may be selected and reported using a wideband codebook (e.g., a NR Type I codebook or an AI/ML generated codebook for wideband report). As an embodiment, some entries of the CSI codebook are reserved for a wideband codebook as fall back in case that the subband selective CSI codebook yields low CSI accuracy. As a different embodiment, a combined CSI codebook which comprises a subset of entries from a subband selective codebook and another subset of entries from a different codebook, for example wideband codebook, can be used. At the same time, the need for CSI compression model (or just the quantization codebook) retraining can be assessed to improve CSI report accuracy.

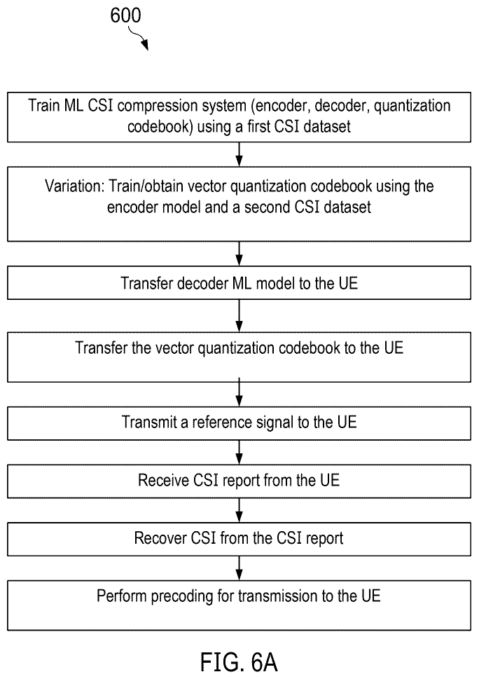

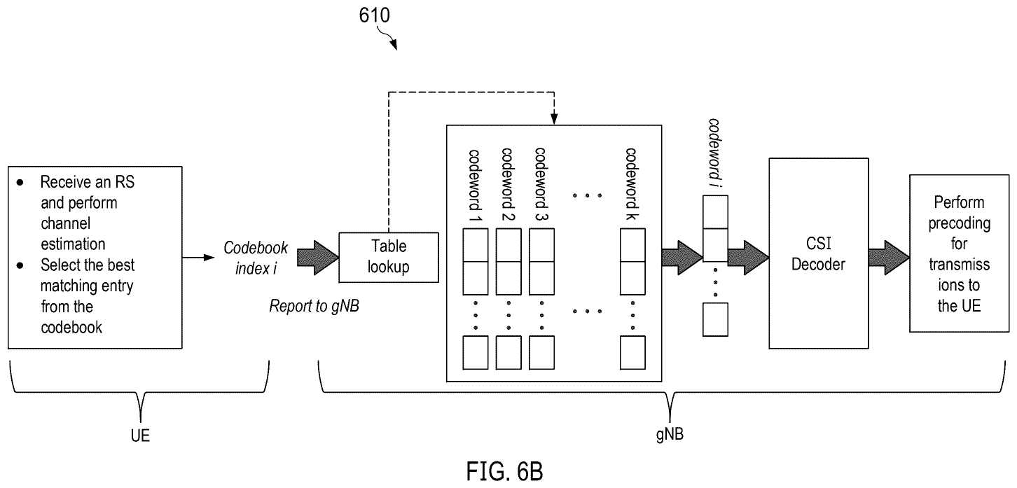

FIG. 6A illustrates a procedure 600 for a BS side according to the disclosure. As an embodiment, a CSI compression ML Model (including a CSI encoder part, a CSI decoder part, and a vector quantizer) is obtained by training (and testing) using a CSI dataset. The CSI encoder part extracts features from high dimensional input data into a lower dimensional vector in which each element is represented in real number space. The vector quantizer encodes the output of CSI encoder from a multidimensional vector space into a finite set of values from a discrete subspace of lower dimension and generates (or obtains) a quantization codebook. The CSI decoder part first recovers the encoded vector in real-number space using the quantization codebook then reconstructs the CSI with the original input dimension. As an embodiment, the CSI is a tensor of complex values with a dimension of # antenna ports×# layers×# subbands. In the case of 32 antenna ports, 2 layers, and 20 subbands, the size is 32×2×20×2=2560. The output of the encoder model can be much smaller, for example, 64 or 128.

In a variation, a CSI compression ML model consisting of only the CSI encoder part and the CSI decoder part can be trained in advance (without the vector quantizer). A quantization codebook for vector quantization may be learned/obtained by a separate step, for example, by using clustering method on the encoder outputs of a CSI dataset. This CSI dataset can be the same (or a subset) of the CSI dataset used for encoder and decoder training. Alternatively, this CSI dataset can be a different CSI dataset, for example, for a specific scenario, or a specific gNB. The vector quantization codebook size can vary depending on the scenario. For very small CSI report/feedback overhead, for example, of 10, 11, 12, or 13 bits, the vector quantization codebook will have 1024, 2048, 4096, or 8192 entries, respectively, and the size of each entry is the size of the encoder output, for example, each entry is a vector of 128 real-number values.

After the training is finished, the decoder part of the CSI compression ML model and the vector quantization codebook are delivered to the UE. As an embodiment, the UE derives a CSI codebook by passing the vector quantization codebook through the decoder part of the CSI compression ML model. An entry of the CSI codebook is the output of the decoder part of the CSI compression when an entry of the vector quantization codebook is used as the input of the decoder part of the CSI compression. Therefore, the number of entries of the CSI codebook is the same as that of the vector quantization codebook. Alternatively, the CSI codebook can be directly transmitted to the UE. However, the overhead of sending CSI codebook directly will be much larger as the dimension (and size) of a CSI codebook entry (which is the same as the CSI, i.e. the input to the encoder) is much larger than that of a vector quantization codebook entry (i.e., the output of the encoder). Another alternative is that the decoder part of the CSI compression ML model and the vector quantization codebook can be sent to the UE separately. For example, a decoder part of the CSI compression ML model can be trained using a large amount of CSI data for various scenarios and only sent to the UE once. The vector quantization codebook can be trained/learned with data for a specific scenario or a specific gNB in order to have even smaller size with good performance for that specific scenario or gNB. The vector quantization can then be updated and delivered to the UE whenever needed to have better tradeoff between performance and overhead.

As an embodiment, a CSI compression ML Model (including a CSI encoder part, a CSI decoder part, and a vector quantizer) can be trained in advance, for example at a server or in a factory. The CSI decoder and the vector quantization codebook are then delivered to the wireless communication devices such as a gNB for 5G NR or a 6G base station and a UE.

As yet another embodiment, a CSI compression ML model consisting of only the CSI encoder part and the CSI decoder part can be trained in advance (without the vector quantizer), for example at a server or in a factory. The CSI encoder and the CSI decoder are then delivered to a wireless communication node such as a gNB for 5G NR or a 6G network controller or base station. A quantization codebook for vector quantization may be learned/obtained at the wireless communication node. For example, using clustering method on the encoder outputs of a CSI dataset. This CSI dataset can be a different CSI dataset from that used for encoder and decoder training, for example, the CSI data set may be for a specific scenario, or a specific gNB. The vector quantization codebook size can vary depending on the scenario. For very small CSI report/feedback overhead, for example, of 10, 11, 12, or 13 bits, the vector quantization codebook will have 1024, 2048, 4096, or 8192 entries and the size of each entry is the size of the encoder output, for example, each entry is a vector of 128 real-number values. The CSI decoder and the vector quantization codebook are then transmitted (together or separately) to another wireless communication node, such as a UE. The vector quantization codebook can be updated more frequently to the UE and its size may vary. Corresponding configuration messages may be sent to the UE, for example via RRC signaling, to inform parameters of the decoder and the vector quantization codebook. As yet another embodiment, the vector quantization codebook can be trained in a different network controller and then delivered to a gNB or a base station which then sends the vector quantization codebook to the UE.

As an embodiment, a gNB or a base station transmits a reference signal (for example, a CSI-RS) to the UE. The gNB receives the index of the CSI codebook from the UE. The selection of the CSI codebook entry at the UE may be based on the estimated CSI at the UE over the reference signal and a selection criterion. The criterion may be, for example, maximizing the received SINR (or CQI), maximizing the data rate of the transmission (or MCS), maximizing GCS (or SGCS) between the estimated CSI and the codebook entries, etc.

FIG. 6B illustrates a procedure 610 at a gNB upon receiving the index of the selected CSI codebook entry from the UE according to the disclosure. The gNB can obtain the vector quantization codebook entry of the index through a table look-up operation and then pass the quantization codebook entry as the input to the decoder to generate an output as the reported CSI. Alternatively, the gNB may derive a CSI codebook by passing the vector quantization codebook through the decoder part of the CSI compression ML model. After receiving the index of the CSI codebook from the UE, the gNB can obtain the CSI codebook entry as the reported CSI. In case that rank is larger than 1, multiple indices may be received by the gNB from the UE. The gNB obtains a CSI codebook entry for each index as the reported CSI for each layer. The gNB may also receive a measure of CSI report accuracy, for example, quantitative GCS (or SGCS) and perform precoding and MIMO scheduling accordingly. Alternatively, a combined CSI codebook which comprises a subset of entries from a subband selective codebook and another subset of entries from a different codebook, for example wideband codebook, can be used. Also, a CSI codebook entry is selected by the gNB according to the received index of the CSI codebook from the UE. The CSI codebook used by the gNB and the CSI codebook used by the UE are the same.

Based on the CSI reported from the UE, the gNB derives the precoding vectors for transmissions of physical layer channel such as PDSCH, PDCCH and the associated DMRS or reference signal such as a CSI-RS and etc. As an example, when CSI reported is the channel matrices, eigenvector(s) may be derived from the CSI reported. Alternatively, the CSI reported is the eigenvector(s) of the channel matrices. The gNB may derive the precoding vector(s) based on the channel eigenvector(s). The gNB may further adjust the precoding vector(s) according to other factors, for example, the CSI of another UE or other UE(s) paired for transmission over the same time and frequency radio resources such as a resource element or a RB for 5G NR or a 5G networks. The gNB then transmits the physical layer channel or signal by applying the precoding vector(s) over the involved transmitting antenna ports.

In wireless communication systems, UEs/handsets typically have limited storage space/memory and computational power to perform ML training task, thus, offline engineering procedure may be used, e.g., a more powerful external server is used to train ML model(s), generate executable images then deploy the executable(s) onto the UEs. On the other hand, the base stations, e.g., gNBs in 5G network, are typically equipped with more storage space/memory and more powerful processing units which are sufficient to train ML models on-site vs. on a separate server. With this advantage, it may be more suitable to train the entire CSI compression ML model, including the autoencoder and the quantizer (with quantization codebook) on the base station(s). Once the training procedure finishes, the decoder and the vector quantization codebook can be delivered to the UEs through upper level protocols and procedures.

The UE, upon deriving or receiving the CSI codebook, may receive and measure a reference signal from a gNB to estimate channel state information. In a typical antenna element-to-element channel estimation, a channel between two devices is estimated by having a first device (e.g., gNB) transmit a known signal on a known time or frequency resource(s) to a second device (e.g., UE), the received signal at the second device is expressible as y=Hs+n, where y is a received signal at the second device, s is a known signal (which may be a reference signal, a pilot, or a pilot signal), H is a channel model, channel response, or channel matrix, and n is a noise (and interference for some communication channels). Because s is known by the second device, it is possible for the second device to determine or estimate H from y. In one example, the reference signal may be a CSI-RS from the gNB.

The UE, upon estimating the CSI, may then select an entry from the CSI codebook based on the estimated CSI and a selection criterion. In one embodiment, the selection criteria may be to maximize generalized cosine similarity (GCS) between the estimated CSI and the codebook entries. For example, the GCS can be expressed as

$$G C S = E \{ \frac{1}{N} {\sum }_{i = 1}^{N} \frac{‖ {\tilde{w}}_{i}^{H} {w}_{i} ‖}{‖ {\tilde{w}}_{i}^{H} ‖ ‖ {w}_{i} ‖} \} \qquad Equation ( 1 )$$

In the equation above, wᵢ is the estimated CSI of resource unit (e.g., subband) i, and \tilde{w}ᵢ is an entry from the CSI codebook of resource unit i, N is the total number of resource units, and E{⋅} denotes the average operation. In one example, wᵢ is the principal eigenvector(s) of the estimated channel matrix H of resource unit i. In one special case, N=1, and the estimated CSI is a wideband CSI and the selected entry from the CSI codebook is for wideband CSI report. The UE may perform exhaustive search to select the best entry of the criteria, e.g., the entry with the highest GCS among all the entries in the CSI codebook.

In another embodiment, the selection criterion may be to maximize squared generalized cosine similarity (SGCS) between the estimated CSI and the codebook entries. For example, the SGCS can be expressed as

$$SGCS = E \{ \frac{1}{N} {\sum }_{i = 1}^{N} {( \frac{‖ {\tilde{w}}_{i}^{H} {w}_{i} ‖}{‖ {\tilde{w}}_{i}^{H} ‖ ‖ {w}_{i} ‖} )}^{2} \} \qquad Equation ( 2 )$$

In the equation above, wᵢ is the estimated CSI of resource unit (e.g., subband) i, and \tilde{w}ᵢ is an entry from the CSI codebook of resource unit i, N is the total number of resource units, and E{⋅} denotes the average operation. In one example, wᵢ is the principal eigenvector(s) of the estimated channel matrix H of resource unit i. Similarly, when N=1, the estimated CSI is a wideband CSI and the searched entry from the CSI codebook is for wideband CSI report. The UE may perform exhaustive search to select the best entry of the criteria, e.g., the entry with the highest SGCS among all the entries in the CSI codebook.

In yet another embodiment, the selection criteria may be to maximize the received signal to interference and noise ratio (SINR), to maximize the CQI, to maximize the achievable data rate of the transmission, or to maximize the achievable modulation and coding scheme (MCS). The entry of the CSI codebook, when applied as CSI or precoding at the transmitter side for transmission over the estimated channel, that maximizes the received SINR (or CQI, achievable data rate, MCS level, etc.) is selected and its index is reported.

In the case of rank >1, e.g., when the estimated channel matrix H has multiple principal eigenvectors and therefore can support multi-layer MIMO transmission, the UE may search the best entry from the CSI codebook for each of the multiple layers. For example, for rank=2, the UE may select a first best entry from the CSI codebook for the first layer and then select a second best entry from the CSI codebook for the second layer in accordance with the selection criteria.

The exhaustive search mentioned above to select the best entry of the criteria is feasible when the codebook size is relatively small. When the codebook size is larger, for example, its representation is larger than 20 bits (or more than 1 million entries), methods may be used to reduce searching complexity. In one example, the entries of the CSI codebook may be divided into multiple groups, each of which comprises a subset of the entries. In each group, there is one representative entry. The UE may first search the best matched group, which is the group having the best match between its representative entry and the estimated CSI according to a selection criteria as described above. The UE may then search the best matched entry from within the group using methods described above.

The UE, upon selecting an entry or multiple entries (e.g., in the case of multi-layer transmission) from the CSI codebook according to the estimated CSI and a selection criterion, may report the index of the selected codebook entry to the gNB. The report may be carried in a PUCCH. Alternatively, the report may be carried in a PUSCH. The report may be sent to the gNB together with CQI, RI, and/or other CSI feedback.

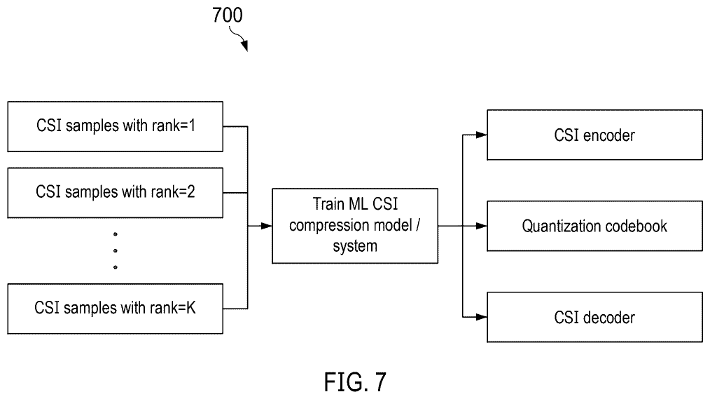

FIG. 7 illustrates a method 700 of a training phase of CSI compression model using samples with various ranks according to the disclosure. In the case rank>1 as explained above, e.g., when the estimated channel matrix H has multiple principal eigenvectors, during the training/learning phase of the proposed ML CSI compression model/system (which consists of an encoder, a vector quantizer/quantization codebook and a decoder), a dataset containing samples of CSI feedbacks with various ranks (e.g., rank=1, rank=2, rank=3 and rank=4) can be used to train the CSI compression ML model. After the training finishes, the trained/learned CSI encoder, vector quantizer/quantization codebook and CSI decoder are suitable to take input from various ranks when they are used in the inference phase.

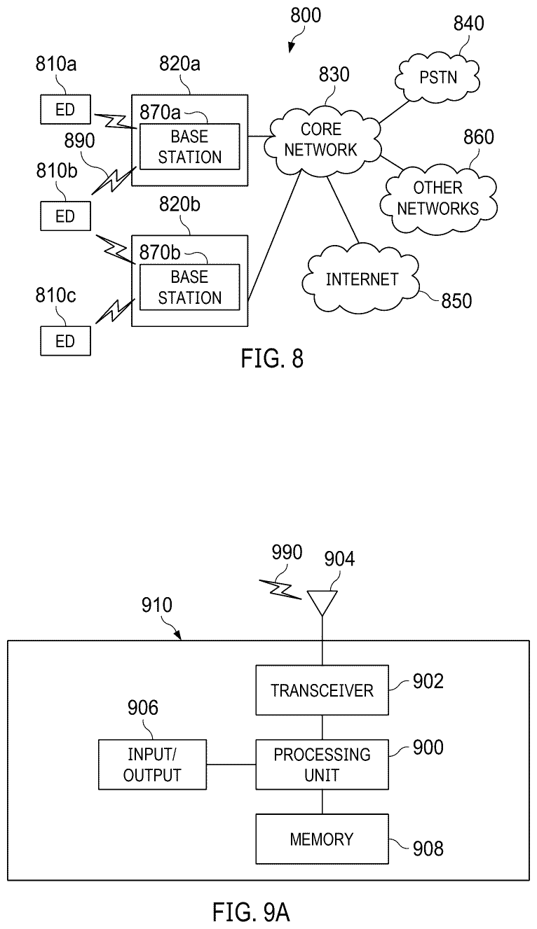

FIG. 8 illustrates an example communication system 800 according to the disclosure. In general, the system 800 enables multiple wireless or wired users to transmit and receive data and other content. The system 800 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 800 includes electronic devices (ED) 810a-810c, radio access networks (RANs) 820a-820b, a core network 830, a public switched telephone network (PSTN) 840, the Internet 850, and other networks 860. While certain numbers of these components or elements are shown in FIG. 8, any number of these components or elements may be included in the system 800.

The EDs 810a-810c are configured to operate or communicate in the system 800. For example, the EDs 810a-810c are configured to transmit or receive via wireless or wired communication channels. Each ED 810a-810c represents any suitable end user device and may include such devices (or may be referred to) as a UE or device, wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 820a-820b here include base stations 870a-870b, respectively. Each base station 870a-870b is configured to wirelessly interface with one or more of the EDs 810a-810c to enable access to the core network 830, the PSTN 840, the Internet 850, or the other networks 860. For example, the base stations 870a-870b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 810a-810c are configured to interface and communicate with the Internet 850 and may access the core network 830, the PSTN 840, or the other networks 860.

In the embodiment shown in FIG. 8, the base station 870a forms part of the RAN 820a, which may include other base stations, elements, or devices. Also, the base station 870b forms part of the RAN 820b, which may include other base stations, elements, or devices. Each base station 870a-870b operates to transmit or receive wireless signals within a particular geographic region or area, sometimes referred to as a “cell.” In some embodiments, multiple-input multiple-output (MIMO) technology may be employed having multiple transceivers for each cell.

The base stations 870a-870b communicate with one or more of the EDs 810a-810c over one or more air interfaces 890 using wireless communication links. The air interfaces 890 may utilize any suitable radio access technology.

It is contemplated that the system 800 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 820a-820b are in communication with the core network 830 to provide the EDs 810a-810c with voice, data, application, Voice over Internet Protocol (VoIP), or other services. Understandably, the RANs 820a-820b or the core network 830 may be in direct or indirect communication with one or more other RANs (not shown). The core network 830 may also serve as a gateway access for other networks (such as the PSTN 840, the Internet 850, and the other networks 860). In addition, some or all of the EDs 810a-810c may include functionality for communicating with different wireless networks over different wireless links using different wireless technologies or protocols. Instead of wireless communication (or in addition thereto), the EDs may communicate via wired communication channels to a service provider or switch (not shown), and to the Internet 850.

Although FIG. 8 illustrates one example of a communication system, various changes may be made to FIG. 8. For example, the communication system 800 could include any number of EDs, base stations, networks, or other components in any suitable configuration.

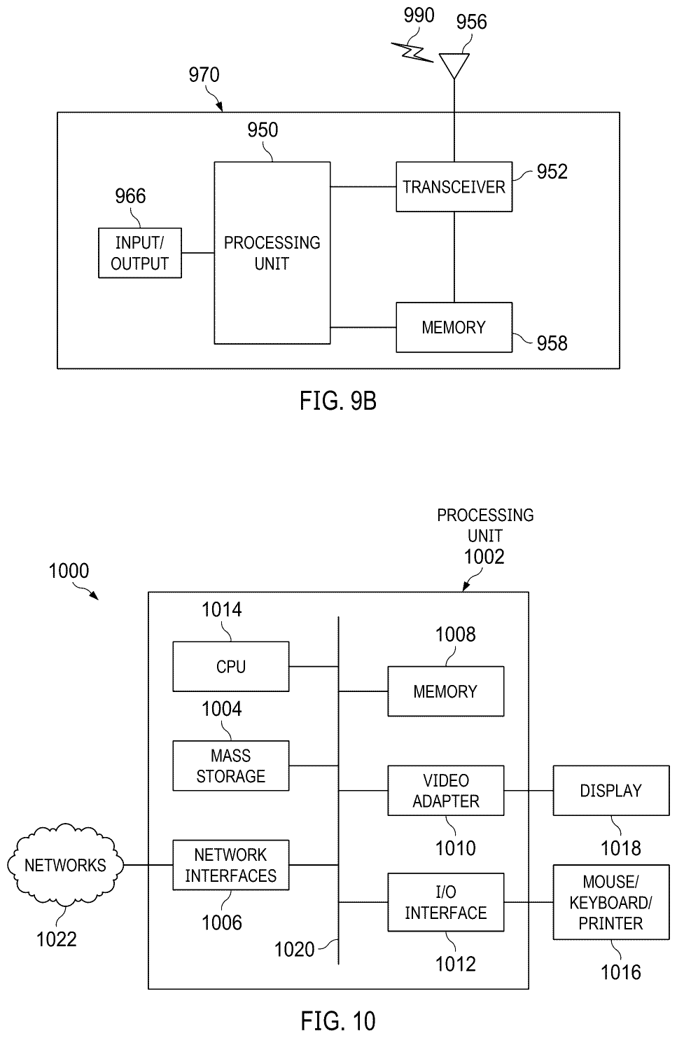

FIGS. 9A and 9B illustrate example devices that may implement the methods and teachings according to this disclosure. In particular, FIG. 9A illustrates an example ED 910 according to the disclosure, and FIG. 9B illustrates an example base station 970 according to the disclosure. These components could be used in the system 800 or in any other suitable system.

As shown in FIG. 9A, the ED 910 includes at least one processing unit 900. The processing unit 900 implements various processing operations of the ED 910. For example, the processing unit 900 could perform signal coding, data processing, power control, input/output processing, or any other functionality enabling the ED 910 to operate in the system 800. The processing unit 900 also supports the methods and teachings described in more detail above. Each processing unit 900 includes any suitable processing or computing device configured to perform one or more operations. Each processing unit 900 could, for example, include a microprocessor, microcontroller, digital signal processor, field programmable gate array, or application specific integrated circuit, or a plurality of such devices.

The ED 910 also includes at least one transceiver 902. The transceiver 902 is configured to modulate data or other content for transmission by at least one antenna or NIC (Network Interface Controller) 904. The transceiver 902 is also configured to demodulate data or other content received by the at least one antenna 904. Each transceiver 902 includes any suitable structure for generating signals for wireless or wired transmission or processing signals received wirelessly or by wire. Each antenna 904 includes any suitable structure for transmitting or receiving wireless or wired signals. One or multiple transceivers 902 could be used in the ED 910, and one or multiple antennas 904 could be used in the ED 910. Although shown as a single functional unit, a transceiver 902 could also be implemented using at least one transmitter and at least one separate receiver.

The ED 910 further includes one or more input/output devices 906 or interfaces (such as a wired interface to the Internet 850). The input/output devices 906 facilitate interaction with a user or other devices (network communications) in the network. Each input/output device 906 includes any suitable structure for providing information to or receiving information from a user, such as a speaker, microphone, keypad, keyboard, display, or touch screen, including network interface communications.

In addition, the ED 910 includes at least one memory 908. The memory 908 stores instructions and data used, generated, or collected by the ED 910. For example, the memory 908 could store software or firmware instructions executed by the processing unit(s) 900 and data used to reduce or eliminate interference in incoming signals. Each memory 908 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 9B, the base station 970 includes at least one processing unit 950, at least one transceiver 952, which includes functionality for a transmitter and a receiver, one or more antennas 956, at least one memory 958, and one or more input/output devices or interfaces 966. A scheduler, which would be understood by one skilled in the art, is coupled to the processing unit 950. The scheduler could be included within or operated separately from the base station 970. The processing unit 950 implements various processing operations of the base station 970, such as signal coding, data processing, power control, input/output processing, or any other functionality. The processing unit 950 can also support the methods and teachings described in more detail above. Each processing unit 950 includes any suitable processing or computing device configured to perform one or more operations. Each processing unit 950 could, for example, include a microprocessor, microcontroller, digital signal processor, field programmable gate array, or application specific integrated circuit, or a plurality of such devices.

Each transceiver 952 includes any suitable structure for generating signals for wireless or wired transmission to one or more EDs or other devices. Each transceiver 952 further includes any suitable structure for processing signals received wirelessly or by wire from one or more EDs or other devices. Although shown combined as a transceiver 952, a transmitter and a receiver could be separate components. Each antenna 956 includes any suitable structure for transmitting or receiving wireless or wired signals. While a common antenna 956 is shown here as being coupled to the transceiver 952, one or more antennas 956 could be coupled to the transceiver(s) 952, allowing separate antennas 956 to be coupled to the transmitter and the receiver if equipped as separate components. Each memory 958 includes any suitable volatile or non-volatile storage and retrieval device(s). Each input/output device 966 facilitates interaction with a user or other devices (network communications) in the network. Each input/output device 966 includes any suitable structure for providing information to or receiving/providing information from a user, including network interface communications.

FIG. 10 is a block diagram of a computing system 1000 according to the disclosure. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1000 includes a processing unit 1002. The processing unit includes a central processing unit (CPU) 1014, memory 1008, and may further include a mass storage device 1004, a video adapter 1010, and an I/O interface 1012 connected to a bus 1020.

The bus 1020 may be one or more of any type of several bus architectures including a memory bus or memory controller, a peripheral bus, or a video bus. The CPU 1014 may comprise any type of electronic data processor or a plurality of such processors. The memory 1008 may comprise any type of non-transitory system memory such as static random access memory (SRAM), dynamic random access memory (DRAM), synchronous DRAM (SDRAM), read-only memory (ROM), or a combination thereof. In an embodiment, the memory 1008 may include ROM for use at boot-up, and DRAM for program and data storage for use while executing programs.

The mass storage 1004 may comprise any type of non-transitory storage device configured to store data, programs, and other information and to make the data, programs, and other information accessible via the bus 1020. The mass storage 1004 may comprise, for example, one or more of a solid state drive, hard disk drive, a magnetic disk drive, or an optical disk drive.

The video adapter 1010 and the I/O interface 1012 provide interfaces to couple external input and output devices to the processing unit 1002. As illustrated, examples of input and output devices include a display 1018 coupled to the video adapter 1010 and a mouse, keyboard, or printer 1016 coupled to the I/O interface 1012. Other devices may be coupled to the processing unit 1002, and additional or fewer interface cards may be utilized. For example, a serial interface such as Universal Serial Bus (USB) (not shown) may be used to provide an interface for an external device.

The processing unit 1002 also includes one or more network interfaces 1006, which may comprise wired links, such as an Ethernet cable, or wireless links to access nodes or different networks. The network interfaces 1006 allow the processing unit 1002 to communicate with remote units via the networks. For example, the network interfaces 1006 may provide wireless communication via one or more transmitters/transmit antennas and one or more receivers/receive antennas. In an embodiment, the processing unit 1002 is coupled to a local-area network 1022 or a wide-area network for data processing and communications with remote devices, such as other processing units, the Internet, or remote storage facilities.

### 1 Introduction of Evaluation Observations

During Radio Access Network (RAN) Working Group (WG) #1 (RAN1) meeting #112, the major conclusions/agreements and working assumptions reached among companies are related to the attributes/performance KPIs and their corresponding definitions to be collected by companies when report evaluation results. Those attributes/KPIs were thus captured in different templates as working assumptions. Different templates are to be used for different training types and separate evaluation templates are to be used to collect results without model generalization vs. results from model generalization cases.

In this contribution, we mainly discuss some of the observations from our evaluation results and share our results using the templates from FL, focusing on CSI compression sub use case belonging to the following areas:
Performance evaluation/comparison across various code size and quantization level combinations when applying vector quantization and scalar quantization techniques.
Evaluation of model generalization across scenarios.

In the study, we use eigenvectors of the channel matrices as input to CSI generation part and as the output from the CSI reconstruction part.

### 2 Discussion on Performance Impact Evaluation Across Code Size and Quantization Level Combinations

When we discuss minimizing the CSI feedback overhead at the UE side while maintaining decent CSI reconstruction performance at the BS side, there is typically a tradeoff between the air interface overhead and performance, e.g., measured by SGCS.

Depending on the quantization method applied, the air interface overhead (in bits) is determined differently. When utilizing scalar quantization method, the number of overhead bits is determined based on the output size of the encoder part of the autoencoder model and the quantization level (e.g., number of bits per code or per output element). When utilizing vector quantization, the overhead is mainly determined by the quantization level or codebook size, e.g., 10 bits would be the overhead if the vector quantization codebook size is 1024. It is the combination of output size of the encoder part of the autoencoder and the quantization level that will jointly determine the reconstruction performance.

To understand how the size of encoder output, referred to as code size in this contribution and the corresponding quantization level may impact the performance, we conducted studies across various combinations of different size of the encoder output (CSI generation part before quantization) and different quantization level that is applied to the encoder output. The purpose of the study is to understand whether there is a sweet spot that can help us decide the proper balance/tradeoff between overhead and performance.

### 2.1 Settings of the Study

We study the performance impact by leveraging both scalar quantization method and vector quantization method and we discuss the results of the two methods separately.

For scalar quantization method, we use the settings/configurations as illustrated in Table 2.1-1.

TABLE 2.1-1
Code size and quantization level settings
for Scalar Quantization method

| Code size | 8 | 16 | 32 | 64 |
|---|---|---|---|---|
| Quantization | 3 bits- | 3 bits- | 3 bits- | 3 bits- |
| level (bits per | 10 bits | 10 bits | 10 bits | 10 bits |
| code) | | | | |
| Total number of | 24 bits- | 48 bits- | 96 bits- | 192 bits- |
| overhead bits | 80 bits | 160 bits | 320 bits | 640 bits |
| after | | | | |
| quantization | | | | |

For vector quantization method, Table 2.1.-2 describes the settings/configurations.

TABLE 2.1-2
Code size and quantization level settings
for Vector Quantization method

| Code size | 32 | 64 | 128 |
|---|---|---|---|
| Quantization level | 9 bits-14 bits | 9 bits-14 bits | 9 bits-14 bits |
| (bits per vector or | | | |
| encoder output) | | | |
| Total number of | 9 bits-14 bits | 9 bits-14 bits | 9 bits-14 bits |
| overhead bits after | | | |
| quantization | | | |

### 2.2 Results from the Study

For scalar quantization, Table 2.2-1 describes the detailed SGCS performance across all the code size and quantization level combinations depicted in the previous section (Table 2.1-1).

TABLE 2.2-1
SGCS comparison across various code size and quantization level
combinations when utilizing Scalar Quantization method

| Code size / | | | | |
|---|---|---|---|---|
| Quantization level | 8 | 16 | 32 | 64 |
| 3 bits/code | 0.793346 | 0.8692189 | 0.9255881 | 0.961385 |
| 4 bits/code | 0.869523 | 0.9306231 | 0.9643229 | 0.981690 |
| 5 bits/code | 0.914717 | 0.9544118 | 0.9754388 | 0.9870765 |
| 6 bits/code | 0.931737 | 0.9626237 | 0.9783951 | 0.9884781 |
| 7 bits/code | 0.936774 | 0.9648578 | 0.9791557 | 0.9888442 |
| 8 bits/code | 0.938166 | 0.9653921 | 0.9793558 | 0.9889379 |
| 9 bits/code | 0.938463 | 0.9655241 | 0.9794007 | 0.9889633 |
| 10 bits/code | 0.938568 | 0.9655632 | 0.9794153 | 0.9889687 |

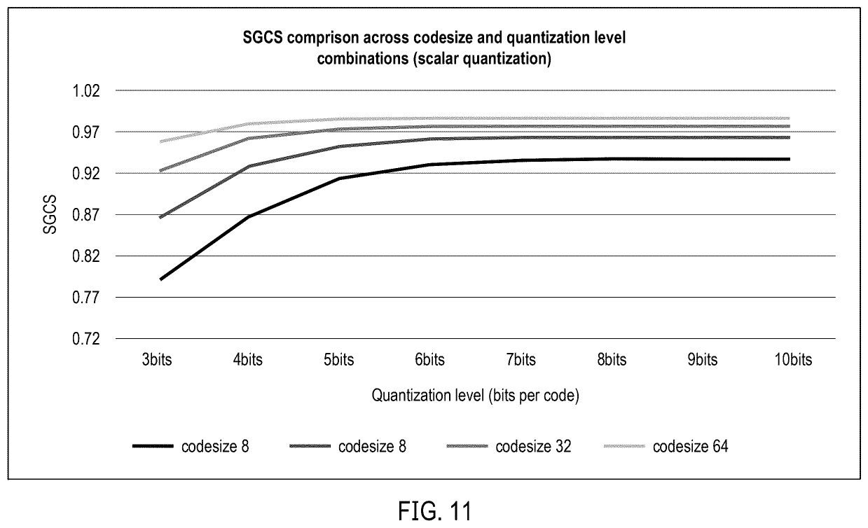

To interpret the impact more easily, FIG. 11 is a graph of performance numbers for Scalar Quantization. From FIG. 11, we can easily observe that performance improvement is very little, or performance saturates when quantization level reaches 6 bits. This observation applies to all code sizes from 8 to 64.

For vector quantization, Table 2.2-2 describes the detailed SGCS performance across all the code size and quantization level combinations depicted in the previous section (Table 2.1-2).

TABLE 2.2-2
SGCS comparison across various code size and quantization level
combinations when utilizing Vector Quantization method

| Code size / | | | |
|---|---|---|---|
| Quantization level | 32 | 64 | 128 |
| 9 overhead bits | 0.6120138 | 0.6219793 | 0.63725171 |
| 10 overhead bits | 0.6743436 | 0.6930799 | 0.69752512 |
| 11 overhead bits | 0.7350976 | 0.751401 | 0.76071956 |
| 12 overhead bits | 0.7888944 | 0.8098408 | 0.82235104 |
| 13 overhead bits | 0.8440014 | 0.8645869 | 0.88241305 |
| 14 overhead bits | 0.8944034 | 0.9128185 | 0.92593642 |

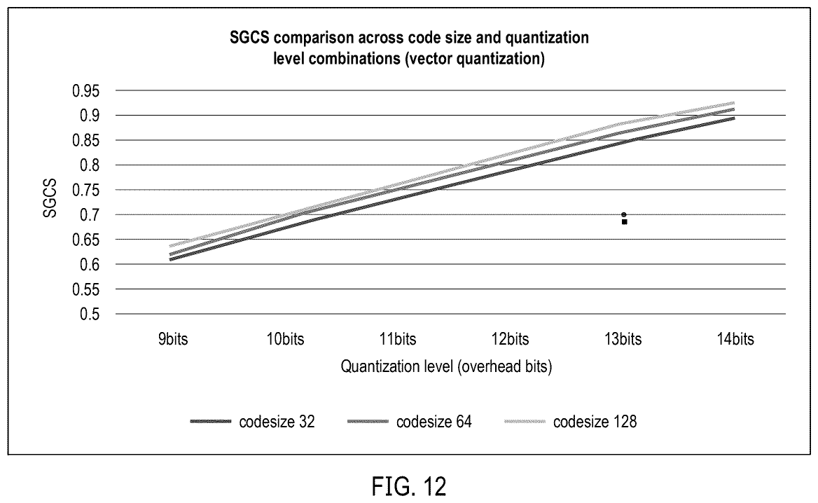

FIG. 12 depicts the performance/SGCS impact when using different code size and codebook size combinations. From FIG. 12, unlike scalar quantization, we observe that SGCS performance improves when quantization level increases when utilizing vector quantization. However, considerations like codebook sharing/transmission air interface overhead and storage space need to be investigated to determine the proper quantization level and code size to balance the tradeoff between performance and overhead.

Observation 1: For CSI feedback compression sub use case, when utilizing scalar quantization (in quantization-aware training), SGCS performance improves with the number of quantization bits per code when lower number of bits are used (e.g., <=6 bits per code observed in our study). However, SGCS performance saturates after quantization level reaches certain point and does not improve much beyond that point (e.g., around 6 bits per code observed in our study).

Observation 2: For CSI feedback compression sub use case, when utilizing scalar quantization (in quantization-aware training), SGCS performance improves when codesize (output size of the CSI generation part before quantization) increases; more noticeable gain is observed in smaller codesize region, e.g., from codesize 8 to codesize 16, particular when smaller number of quantization bits are used in our study, and the performance gain becomes smaller in larger codesize region, e.g., from codesize 32 to codesize 64, particular when larger number of quantization bits are used.

Observation 3: For CSI feedback compression sub use case, when utilizing vector quantization (in quantization-aware training), SGCS performance improves with the number of quantization bits per CSI output while the codesize (output size of the CSI generation part before quantization) increase does not impact performance significantly even though gradual improvement is observed.

Proposal 1: For CSI feedback compression sub use case, when utilizing scalar quantization method to quantize each code in the output of the CSI generation part, determine the optimal quantization level, i.e., number of bits per code, based on the performance saturation point where performance improvement is no longer significant and the total number of overhead bits.

Proposal 2: For CSI feedback compression sub use case, when utilizing vector quantization method to quantize the entire output of the CSI generation part (i.e., a vector), determine the proper codesize and quantization level combination based on the balance/tradeoff between performance and overhead incurred in codebook storage and codebook transmission over the air interface.

### 3 Discussion on Improving Performance and Robustness of Vector Quantization

### 3.1 Motivation and Approach Description

From the results discussed in the previous section by using a typical autoencoder-based CSI compression and reconstruction procedure as depicted in FIG. 3B, we observe utilizing vector quantization can more significantly reduce CSI overhead compared to scalar quantization-based approach, e.g., ˜10 bits CSI overhead vs. >100 bits CSI overhead. However, there is room for performance improvement as using the trained CSI generation part and the quantizer to directly predict which codebook entry to use as the CSI feedback may not always produce the optimal result in the situation that the new/unseen input (e.g., eigenvectors or channel matrix) falls in some region that is not well represented in the training dataset. In this section, we discuss mechanism to improve the performance of vector quantization, particular for low performance region.

We use training collaboration Type 1 as a starting point, in which the AI/ML model for CSI compression is trained on the NW side and maintain most of the procedures as shown in FIG. 3B with some modifications.

During the training phase, the training entity, e.g., gNB generates a CSI generation part, the corresponding vector quantization codebook, and a CSI reconstruction part. The quantization codebook and the CSI reconstruction part are delivered to the UE side (e.g., via model transmission) after training/testing is finished vs. delivering the CSI generation part to UE side. At the UE side, once it receives the quantization codebook and the CSI reconstruction part, it derives a CSI codebook by using the vector quantization codebook entries as input to the CSI reconstruction part of the AI/ML model, which is referred as CSI LUT later in the document.

During the inference/testing phase, for each testing sample/input (e.g., eigenvectors of channel matrix), instead of using the CSI generation part and the quantizer to generate the CSI feedback at the UE side, UE selects an entry from the LUT (derived during the training phase described above) based on the estimated CSI and a selection criterion, e.g., SGCS used in our study. The LUT entry that has the highest SGCS will be selected as the CSI feedback, and the index of the selected LUT entry will be reported to gNB. gNB recovers the CSI/eigenvectors using the same quantization codebook and the CSI reconstruction part and perform precoding (and MIMO transmission) based on the reconstructed CSI, then UPT will be determined accordingly in the simulation case.

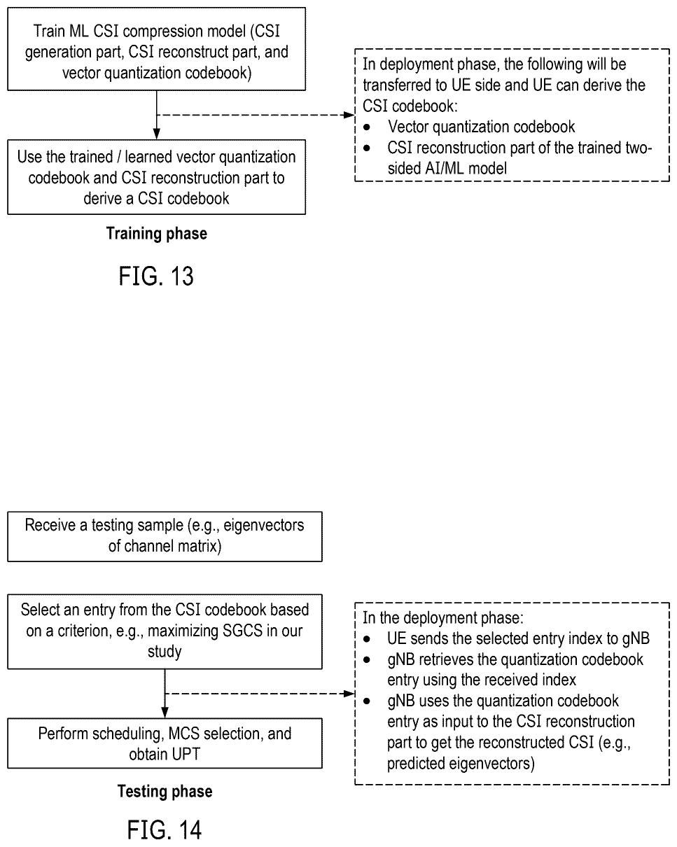

In the simulation environment, we conducted our study (including model training and inference) based on the above procedures with some adjustments. FIG. 13 depicts example procedures of an AI/ML model training phase according to the disclosure and FIG. 14 describes the procedures during the model inference/testing phase according to the disclosure that utilize our proposed method to determine the CSI feedback (i.e., selecting the best entry from the CSI LUT based on SGCS).

### 3.2 Result Evaluation

To better understand how various approaches perform, we compare SGCS performance across the following approaches:
The new approach which determines the CSI feedback by selecting the best-match CSI LUT entry based on the estimated CSI and SGCS.
Typical AI/ML model-based approach that predicts the CSI feedback using the CSI generation part and vector quantizer/vector quantization codebook.
AI/ML model-based approach without quantization.
Rel-16 Type II codebook.

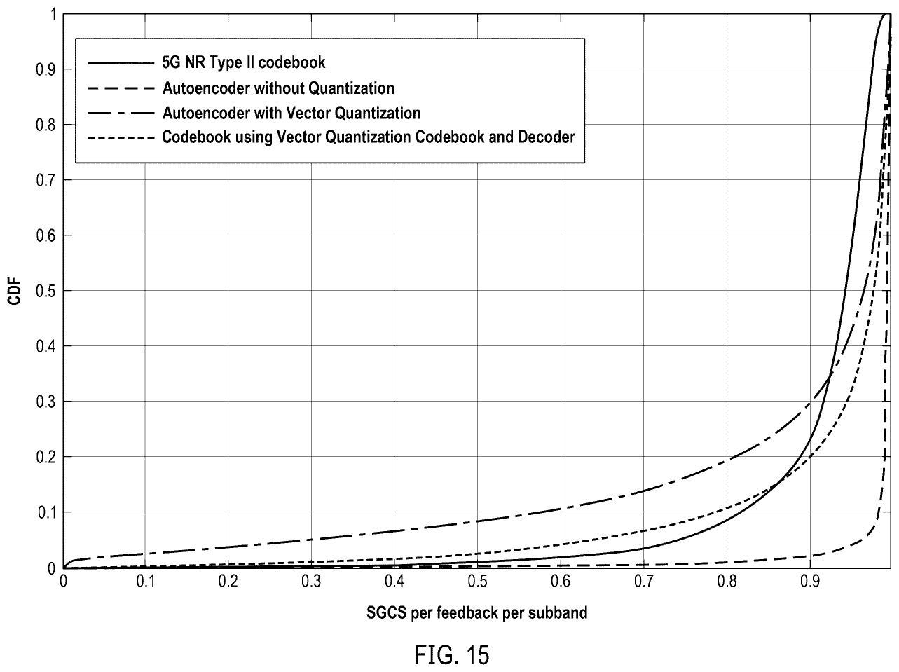

FIG. 15 is a CDF comparison plot for the 4 approaches described above for CSI reporting according to the disclosure. From FIG. 15, we can clearly observe that the new approach outperforms typical AI/ML model-based approach that predicts the CSI feedback using the CSI generation part and vector quantizer, particularly in the low performance region. The new approach also outperforms Rel-16 Type II codebook-based approach for-85% of the testing samples.

The above-described procedures are used in the subsequent performance evaluation sections where vector quantization method is utilized.

Observation 4: For CSI feedback compression sub use case, determining CSI feedback by using a CSI look-up-table constructed from the CSI reconstruction part and a vector quantization codebook shows promising result compared to both Rel-16 Type II codebook-based approach and typical AI/ML model-based approach that uses the CSI generation part and vector quantizer/vector quantization codebook to predict the CSI feedback.

Proposal 3: For CSI feedback compression sub use case, further study the robustness and feasibility of using a CSI look-up-table (constructed from the CSI reconstruction part and a vector quantization codebook) based approach to determine the CSI feedback.

### 4 Discussions on Evaluation Results for CSI Compression Sub Use Case

In this section, we discuss the results of CSI compression sub use case for model generalization performance evaluation. The following generalization case is evaluated: Deployment scenarios: UMa and UMi

### 4.1 Evaluation of Model Generalization Between UMa and UMi Scenarios

### 4.1.1 Simulation Configurations for Dataset Generation and Evaluation Settings

Table 4.1.1-1 below specifies the simulation configurations for generating the UMa and UMi datasets that we used to evaluate model generalization and the results included in this document.

TABLE 4.1.1-1
Simulation parameters for UMa/UMi dataset generation

| Parameter | Value |
|---|---|
| Duplex, Waveform | FDD, OFDM |
| Scenario | Dense Urban (Macro/Micro only) |
| Frequency Range | FR1 only, 4 GHz. |
| Antenna setup and | 32 ports: (8, 8, 2, 1, 1, 2, 8), |
| port layouts at gNB | (dH, dV) = (0.5, 0.8)A |
| Antenna setup and | 4RX: (1, 2, 2, 1, 1, 1, 2), |
| port layouts at UE | (dH, dV) = (0.5, 0.5)A for (rank 1) |
| BS Tx power | 44 dBm for 20 MHz |
| Numerology: SCS | 30 kHz for 4 GHz |
| UE distribution | 100% outdoor (3 km/h) |

In RAN #110, companies reached agreement on the following generalization evaluation cases.

### Agreement

The following cases are considered for verifying the generalization performance of an AI/ML model over various scenarios/configurations as a starting point:
Case 1: The AI/ML model is trained based on training dataset from one Scenario #A/Configuration #A, and then the AI/ML model performs inference/test on a dataset from the same Scenario #A/Configuration #A
Case 2: The AI/ML model is trained based on training dataset from one Scenario #A/Configuration #A, and then the AI/ML model performs inference/test on a different dataset than Scenario #A/Configuration #A, e.g., Scenario #B/Configuration #B, Scenario #A/Configuration #B
Case 3: The AI/ML model is trained based on training dataset constructed by mixing datasets from multiple scenarios/configurations including Scenario #A/Configuration #A and a different dataset than Scenario #A/Configuration #A, e.g., Scenario #B/Configuration #B, Scenario #A/Configuration #B, and then the AI/ML model performs inference/test on a dataset from a single Scenario/Configuration from the multiple scenarios/configurations, e.g., Scenario #A/Configuration #A, Scenario #B/Configuration #B, Scenario #A/Configuration #B.
   Note: Companies to report the ratio for dataset mixing
   Note: number of the multiple scenarios/configurations can be larger than two
FFS the detailed set of scenarios/configurations
FFS other cases for generalization verification, e.g.,
   Case 2A: The AI/ML model is trained based on training dataset from one Scenario #A/Configuration #A, and then the AI/ML model is updated based on a fine-tuning dataset different than Scenario #A/Configuration #A, e.g., Scenario #B/Configuration #B, Scenario #A/Configuration #B. After that, the AI/ML model is tested on a different dataset than Scenario #A/Configuration #A, e.g., subject to Scenario #B/Configuration #B, Scenario #A/Configuration #B.

Case 1 is scenario-based solution and can be considered as the baseline whose performance is the upper bound for the target scenario. In our study, we consider the source scenario is either UMa or UMi and the target scenario is also either UMi or UMa. The following settings are considered in our study:
Case 1: AI/ML model is trained using dataset generated directly from the target scenario and the trained AI/ML model performs inference/test on a separate dataset also from the same scenario. For example, in the case that UMa is the target scenario, the AI/ML model is training using dataset generated from UMa and the testing dataset is generated also from UMa.
Case 2: AI/ML model is trained using dataset generated from the source, i.e., UMa scenario and the trained AI/ML model performs inference/test directly on a dataset generated from the target, which is a different scenario than the source, i.e., UMi scenario.
Case 3: AI/ML model is trained using mixed datasets from the source, i.e., UMa scenario as well as the target, i.e., UMi scenario and the trained AI/ML model performs inference/test on a dataset generated from one of the 2 scenarios.

In the following sub sections, we discuss our study results at high level. The detailed results of our study for model generalization between UMa and UMi scenarios are available in the accompanied Excel file (under Tab “Deployment scenarios, rank=1”). Please refer to the Excel for the assumptions and other configuration details.

### 4.1.2 Evaluation Results

In our study of the model generalization, we use vector quantization method as it typically can reduce the CSI feedback much more than the scalar quantization method.

### 1. Generalization Case 1

Table 4.1.2-1 summarizes the results and comparison among Case 1 (which is considered as baseline for the target scenario, i.e., UMa or UMi).

TABLE 4.1.2-1
Generalization Case 1 performance for UMa and UMi scenarios

| | | | | CSI | |
|---|---|---|---|---|---|
| Training | Testing | Dataset size | | overhead | |
| scenario | scenario | Train | Test | (bits) | SGCS |
| UMa 4 GHz | UMa 4 GHz | 47168 | 9112 | 13 | 0.919497080 |
| UMi 4 GHz | UMi 4 GHz | 47168 | 9112 | 13 | 0.935937172 |

### 2. Generalization Case 2

For model generalization Case 2, the following 2 sub cases are evaluated:
a) The AI/ML model is trained using training dataset from UMa scenario and the trained AI/ML model performs inference/test on a dataset generated from UMi scenario
b) The AI/ML model is trained using training dataset from UMi scenario and the trained AI/ML model performs inference/test on a dataset generated from UMa scenario

Table 4.1.2-2 summarizes SGCS performance for the above 2 sub cases of generalization Case 2.

TABLE 4.1.2-2
Generalization Case 2 performance for “UMa to UMi”
and “UMi to UMa” sub cases

| | | | | CSI | |
|---|---|---|---|---|---|
| Training | Testing | Dataset size | | overhead | |
| scenario | scenario | Train | Test | (bits) | SGCS |
| UMa 4 GHz | UMi 4 GHz | 47168 | 9112 | 13 | 0.76252299 |
| UMi 4 GHz | UMa 4 GHz | 47168 | 9112 | 13 | 0.78882595 |

Comparing the baseline performance, i.e., generalization Case 1 (as illustrated in Table 4.1.2-1) and the results from generalization Case 2 (as shown in Table 4.1.2-2), significant performance degradation is observed when using the AJ/ML model trained with dataset generated from UMa scenario to directly perform inference on dataset generated from UMi scenario. Significant performance degradation is also observed when using the AJ/ML model trained with dataset generated from UMi scenario to directly perform inference on dataset generated from UMa scenario.

### 3. Generalization Case 3

For model generalization Case 3, a mixed dataset containing data samples generated from both UMa scenario and UMi scenario is used to train the AI/ML model. After the training, the AJ/ML model is used to perform inference on either a dataset generated from UMa scenario, or a dataset generated from UMi scenario. The performance is evaluated for the 2 sub cases separately.

Table 4.1.2-3 summarizes SGCS performance for the above 2 sub cases of generalization Case 3.

TABLE 4.1.2-3
Generalization Case 3 performance for using mixed-dataset-model
to perform inference on UMa and UMi scenarios separately

| | | | | CSI | |
|---|---|---|---|---|---|
| Training | Testing | Dataset size | | overhead | |
| scenario | scenario | Train | Test | (bits) | SGCS |
| UMa 4 GHz + | UMai 4 GHz | 94336 | 9112 | 13 | 0.93695240 |
| UMi 4 GHz | UMi 4 GHz | 94336 | 9112 | 13 | 0.93017115 |

Comparing the results from generalization Case 2 (as illustrated in Table 4.1.2-2) and the results from generalization Case 3 (as shown in Table 4.1.2-3), it is evident that using mixed dataset from source scenario and target scenario (i.e., UMa and UMi scenarios in our study) has better performance during model inference phase than naively transmitting the model trained using dataset from the source scenario to perform inference on the target scenario directly (i.e., when either the source scenario is UMa and the target scenario is UMi, or the source scenario is UMi and the target scenario is UMa).

To understand more details of the performance, we plotted CDFs to compare the SGCS distributions among generalization Case1 (baseline for scenario-based model, i.e., training dataset is from UMa and testing dataset is also from UMa, or training dataset is from UMi and testing dataset is also from UMi), generalization Case2 (naive model transmission, i.e., training dataset is from UMi and testing dataset is from UMa, or training dataset is from UMa and testing dataset is from UMi), and generalization Case3 (mixed dataset, i.e., training dataset is from both UMa and UMi and testing data is from UMa, or UMi).

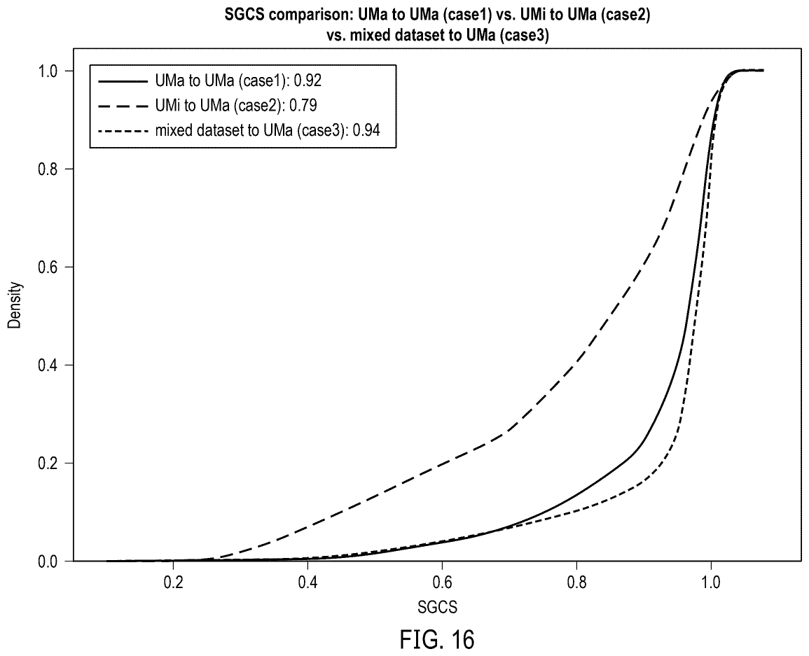

FIG. 16 depicts the SGCS CDF comparison among different generalization cases according to the disclosure when the target scenario is UMa (meaning AI/ML model is to be used for this scenario):
Case1: UMa model to predict testing samples from UMa scenario
Case2: UMi model to predict testing samples from UMa scenario
Case3: mixed dataset model to predict testing samples from UMa scenario

From FIG. 16 and the summarized performance results specified in Table 4.1.2-1, Table 4.1.2-2 and Table 4.1.2-3, we can observe that the SGCS performance for Case 1, which is considered as the baseline for scenario-based model, is very decent with average SGCS of 0.92. Compared to Case 1, the performance of Case 2, in which the AI/ML model trained using data from UMi is naively transmitted to perform inference on data generated from UMa, is significantly degraded. For generalization Case 3, in which the AI/ML is trained using mixed datasets from UMa and UMi, then the trained model is used to perform inference on dataset from UMa, the performance is almost the same as the baseline result from scenario-based model with average SGCS of 0.94.

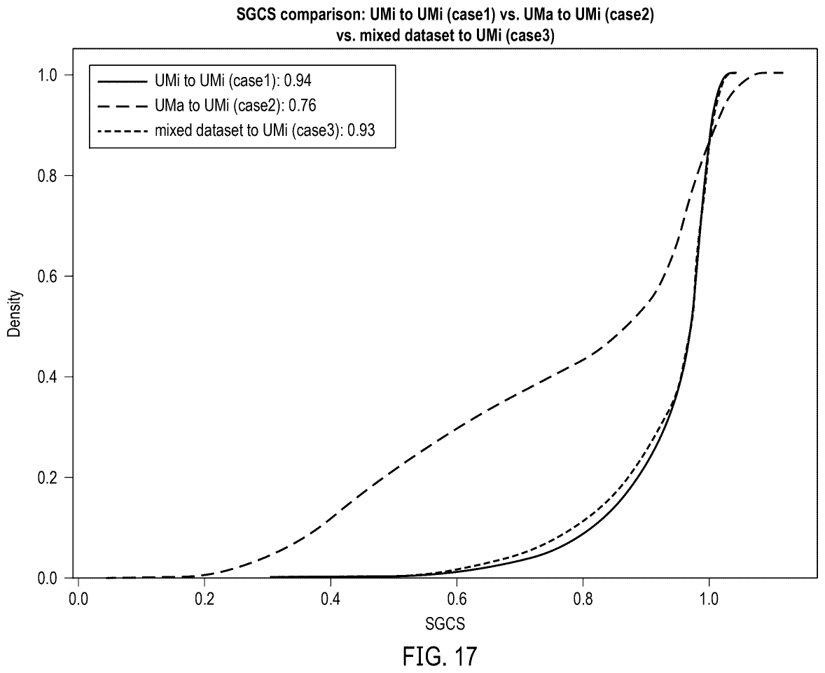

FIG. 17 depicts the SGCS distribution comparison among different generalization cases according to the disclosure when the target scenario is UMi (meaning AI/ML model is to be used for this scenario):
Case1: UMi model to predict testing samples from UMi scenario
Case2: UMa model to predict testing samples from UMi scenario
Case3: mixed dataset model to predict testing samples from UMi scenario

We observe consistent behavior when the target scenario is UMi in our study. From FIG. 17 and the summarized performance results specified in Table 4.1.2-1, Table 4.1.2-2 and Table 4.1.2-3, we can observe that the SGCS performance for Case1, which is considered as the baseline for scenario-based model (for UMi in this case), is also very decent with average SGCS of 0.94. Compared to Case1, the performance of Case 2, in which the AI/ML model trained using data from UMa is naively transmitted to perform inference on data generated from UMi, is significantly degraded (average SGCS only reached 0.76). For generalization Case 3, in which the AI/ML is trained using mixed datasets from UMa and UMi, then the trained model is used to perform inference on dataset from UMi, the performance is almost the same as the baseline result for UMi (Case 1) with average SGCS of 0.93.

Observation 5: For generalization Case 1, when the AI/ML model is trained using dataset generated from one scenario then performs inference on a dataset generated from the same scenario, performance (as measured by SGCS) is very decent, at least for UMa to UMa and UMi to UMi cases.

Observation 6: For generalization Case 2, when the AI/ML model is trained using dataset generated from one scenario then performs inference on a dataset generated from another scenario, significant performance degradation is observed compared to the baseline performance (generalization Case 1), at least for UMa to UMi and UMi to UMa cases.

Observation 7: For generalization Case 3, when the AI/ML model is trained using training dataset constructed by mixing datasets from multiple scenarios, then performs inference on one of the scenarios, the SGCS performance is comparable to the baselines (generalization Case 1), at least between UMa and UMi scenarios.

Proposal 4: For CSI feedback compression sub use case, if the goal is to use the AI/ML model to perform inference in multiple target scenarios, then using a mixed training dataset that is constructed from multiple scenarios, i.e., from those target scenarios, can be considered to improve performance.

### 5 System Level Performance Evaluation Results

In this section, we present our SLS result. The key system level simulation configuration parameters are the same as those used for dataset generation as specified in Table 4.1.1-1. All UEs are limited with rank 1 feedbacks and transmissions. The ML model's input is based on ideal channel.

During RAN1 #112 meetings, companies reached agreement on using the following working assumption to group CSI feedback payloads into X, Y and Z ranges to facilitate discussion and result comparisons. The working assumption is captured below.

Working Assumption

For the initial template for AI/ML-based CSI compression without
generalization/scalability verification achieved in the working
assumption in the RAN1#111 meeting, X, Y and Z are determined as:
X is <=80 bits
Y is 100 bits-140 bits
Z is >=230 bits

Based on the above categorization of CSI feedback overhead, we constructed our study in the following areas:
Rel-16 Type II codebook-based approach
   For each overhead range (X, Y and Z), select a configuration combination that generates CSI feedback overhead bits in that range.
   Calculate average UPT and 5% UPT based on system level simulation.
AI/ML based approach
   For each overhead range (X, Y and Z), identify a combination of code size (output size of the encoder in the CSI generation part) and quantization level that generates CSI feedback overhead bits in that range.
   Based on the identified combination, train the AI/ML model (including the CSI generation part and CSI reconstruction part) and the quantizer/quantization codebook accordingly.
   Integrate the trained AI/ML model into system level simulation environment to perform scheduling and MCS selection and calculate average UPT and 5% UPT based on the system level simulation result.

In our study, we adopt either vector quantization method or scalar quantization method depending on the identified CSI feedback overhead bits. For very small CSI overhead bits, e.g., <14 bits, we use vector quantization method and for larger CSI overhead bits we use scalar quantization method to generate similar number of overheads as Rel-16 Type II codebook-based approach.

Table 5-1 describes the identified CSI overhead bits we use in our study in each of the X, Y and Z category.

TABLE 5-1
mapping between CSI overhead bits
and X, Y, Z categories in our study

| | X | Y | Z |
|---|---|---|---|
| Approach | (<=80 bits) | (100-140 bits) | (>=230 bits) |
| Rel-16 Type | 49 bits | 130 bits | 242 bits |
| II codebook | | | |
| AI/ML based | 13 bits (vector | 108 bits and | 240 bits (scalar |
| | quantization) and | 128 bits (scalar | quantization) |
| | 48 bits (scalar | quantization) | |
| | quantization) | | |

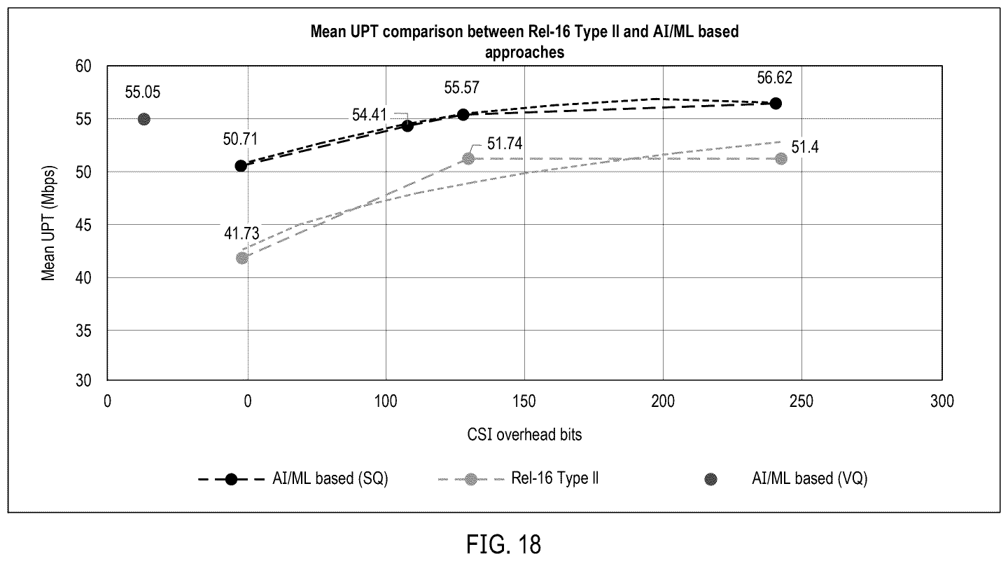

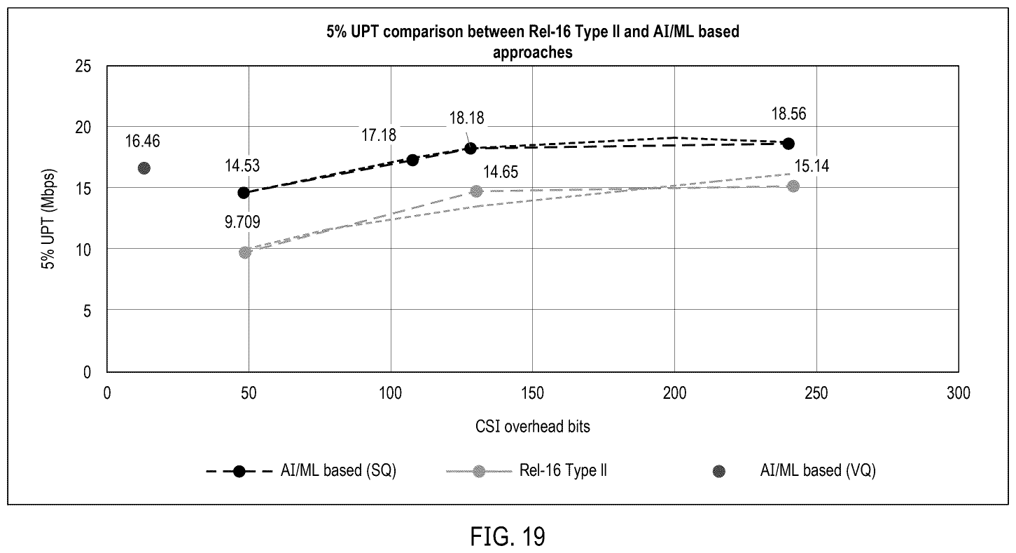

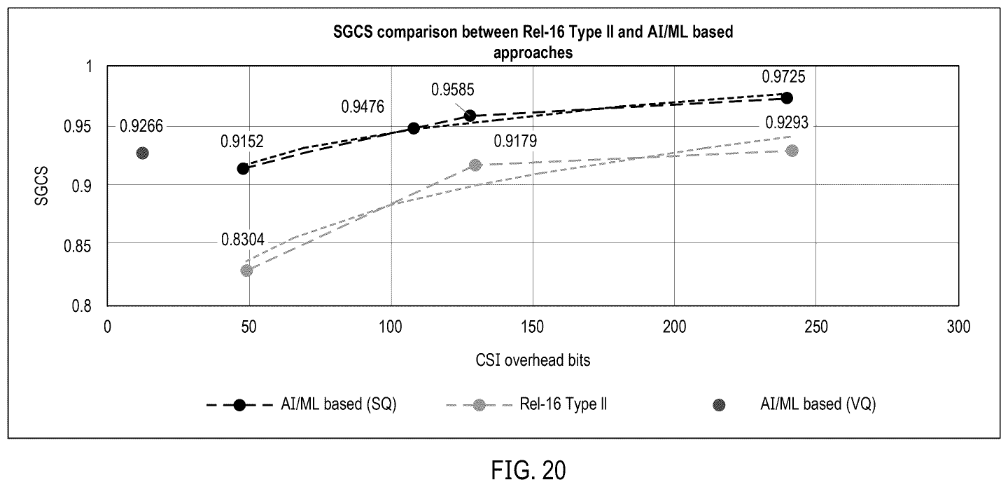

In the following sub sections, we discuss our study results at high level. FIG. 18 depicts a Mean UPT performance comparison between a baseline, i.e., Rel-16 Type II codebook-based approach and an AI/ML based approach, FIG. 19 shows the corresponding 5% UPT performance comparison, and FIG. 20 shows the corresponding SGCS performance comparison.

In the figures, lighter gray dashed lines are Rel-16 Type II codebook-based performance and darker gray dashed lines represent the performance of AI/ML based approach using scalar quantization method across various CSI overhead bits selected based on CSI overhead categories X, Y and Z as agreed in RAN1 #112 as described in Table 5-1. The singleton dot represents the performance of AI/ML based approach using vector quantization method (see Table 5-1). The dashed lines are used to connect points together directly and the dotted lines are the corresponding polynomial fittings.

From FIGS. 17-19, we can observe noticeable performance gains in AI/ML based CSI compression compared to Rel-16 Type II codebook-based approach.

When using scalar quantization, Table 5-2 summarizes the Mean UPT comparison between AI/ML based CSI compression and Rel-16 Type II codebook-based baseline approach. Table 5-3 summarizes the 5% UPT comparison between AI/ML based CSI compression and Rel-16 Type II codebook-based baseline approach (with some interpolation). From both tables, the throughput gains from AI/ML-based CSI compression are more significant when number of overhead bits is low. For example, when CSI feedback is 50 bits, AI/ML based approach achieved 21.4% gain in Mean UPT gain and 54.5% gain in 5% UPT.

TABLE 5-2
Mean UPT comparison between Rel-16 Type II codebook-based approach
and AI/ML based approach for overhead category X, Y and Z

| | Overhead | Mean UPT | Mean UPT | |
|---|---|---|---|---|
| Category | bits | (AI/ML) | (Rel-16 Type II) | Gain |
| X | 50 bits | ~51 | ~42 | 21.4% |
| Y | 130 bits | ~56 | 51.4 | 8.9% |
| Z | 240 bits | 56.62 | ~52 | 8.9% |
| Average | | | | 13.1% |

TABLE 5-3
5% UPT comparison between Rel-16 Type II codebook-based approach
and AI/ML based approach for overhead category X, Y and Z

| | Overhead | 5% UPT | 5% UPT | |
|---|---|---|---|---|
| Category | bits | (AI/ML) | (Rel-16 Type II) | Gain |
| X | 50 bits | ~15 | ~9.71 | 54.5% |
| Y | 130 bits | ~18.2 | 14.65 | 24.2% |
| Z | 240 bits | 18.56 | ~15.15 | 22.5% |
| Average | | | | 33.7% |

When using vector quantization method with only 13 CSI overhead bits, AI/ML-based approach achieves better Mean UPT and 5% UPT than Rel-16 Type II codebook-based baseline with 242 overhead bits.

Observation 8: For CSI feedback compression sub use case, when using scalar quantization AI/ML-based approach outperforms Rel-16 Type II codebook-based approach in all 3 overhead categories, X, Y and Z with ˜13.1% average Mean UPT gain and ˜33.7% average 5% UPT gain.

Observation 9: For CSI feedback compression sub use case, when using vector quantization, AI/ML-based approach with 13 CSI overhead bits achieves better Mean UPT and 5% UPT than Rel-16 Type II codebook-based approach with 10 times more overhead bits, e.g., 130 or 242 CSI bits.

### 6 Conclusions of Evaluation Observations

In this contribution, we summarized the evaluation results of CSI feedback compression sub use case when using eigenvectors as input/output of AI/ML model(s) and discussed our study on performance impact of both vector quantization and scalar quantization when quantization level changes across various encoder output sizes. We also discussed our system level performance results and comparisons between using Rel-16 Type II codebook (baseline) and AI/ML based approaches. Our observations and proposals are as follows.

Proposal 1: For CSI feedback compression sub use case, when utilizing scalar quantization method to quantize each code in the output of the CSI generation part, determine the optimal quantization level, i.e., number of bits per code, based on the performance saturation point where performance improvement is no longer significant and the total number of overhead bits.

Proposal 2: For CSI feedback compression sub use case, when utilizing vector quantization method to quantize the entire output the CSI generation part (i.e., a vector), determine the proper codesize and quantization level combination based on the balance/tradeoff between performance and overhead incurred in codebook storage and codebook transmission over the air interface.

Proposal 3: For CSI feedback compression sub use case, further study the robustness and feasibility of using a CSI look-up-table (constructed from the CSI reconstruction part and a vector quantization codebook) based approach to determine the CSI feedback.

Proposal 4: For CSI feedback compression sub use case, if the goal is to use the AI/ML model to perform inference in multiple target scenarios, then using a mixed training dataset that is constructed from multiple scenarios, i.e., from those target scenarios, can be considered to improve performance.

Observation 1: For CSI feedback compression sub use case, when utilizing scalar quantization (in quantization-aware training), SGCS performance improves with the number of quantization bits per code when lower number of bits are used (e.g., <=6 bits per code observed in our study). However, SGCS performance saturates after quantization level reaches certain point and does not improve much beyond that point (e.g., around 6 bits per code observed in our study).

Observation 2: For CSI feedback compression sub use case, when utilizing scalar quantization (in quantization-aware training), SGCS performance improves when codesize (output size of the CSI generation part before quantization) increases; more noticeable gain is observed in smaller codesize region, e.g., from codesize 8 to codesize 16, particular when smaller number of quantization bits are used in our study, and the performance gain becomes smaller in larger codesize region, e.g., from codesize 32 to codesize 64, particular when larger number of quantization bits are used.

Observation 3: For CSI feedback compression sub use case, when utilizing vector quantization (in quantization-aware training), SGCS performance improves with the number of quantization bits per CSI output while the codesize (output size of the CSI generation part before quantization) increase does not impact performance significantly even though gradual improvement is observed.

Observation 4: For CSI feedback compression sub use case, determining CSI feedback by using a CSI look-up-table constructed from the CSI reconstruction part and a vector quantization codebook shows promising result compared to both Rel-16 Type II codebook-based approach and typical AI/ML model-based approach that uses the CSI generation part and vector quantizer/vector quantization codebook to predict the CSI feedback.

Observation 5: For generalization Case 1, when the AI/ML model is trained using dataset generated from one scenario then performs inference on a dataset generated from the same scenario, performance (as measured by SGCS) is very decent, at least for UMa to UMa and UMi to UMi cases.

Observation 6: For generalization Case 2, when the AI/ML model is trained using dataset generated from one scenario then performs inference on a dataset generated from another scenario, significant performance degradation is observed compared to the baseline performance (generalization Case 1), at least for UMa to UMi and UMi to UMa cases.

Observation 7: For generalization Case 3, when the AI/ML model is trained using training dataset constructed by mixing datasets from multiple scenarios, then performs inference on one of the scenarios, the SGCS performance is comparable to the baselines (generalization Case 1), at least between UMa and UMi scenarios.

Observation 8: For CSI feedback compression sub use case, when using scalar quantization AI/ML-based approach outperforms Rel-16 Type II codebook-based approach in all 3 overhead categories, X, Y and Z with ˜13.1% average Mean UPT gain and ˜33.7% average 5% UPT gain.

Observation 9: For CSI feedback compression sub use case, when using vector quantization, AI/ML-based approach with 13 CSI overhead bits achieves better Mean UPT and 5% UPT than Rel-16 Type II codebook-based approach with 10 times more overhead bits, e.g., 130 or 242 CSI bits.

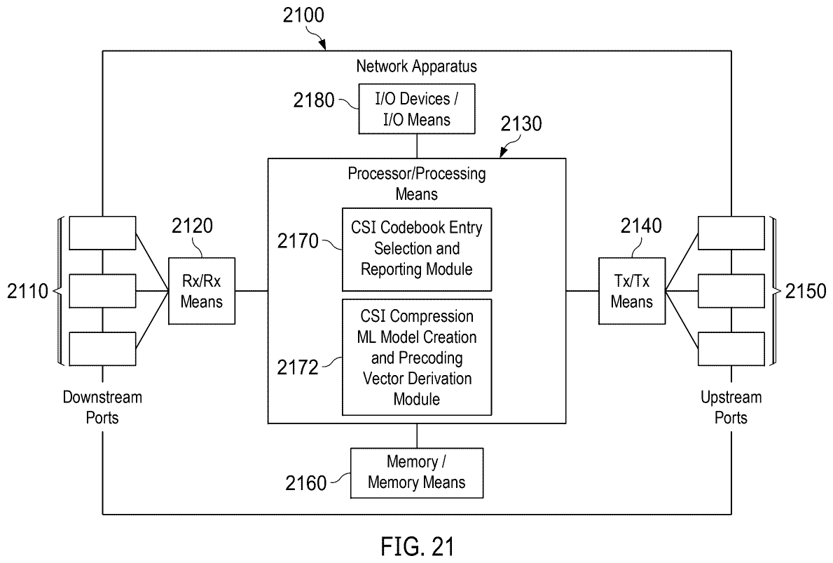

FIG. 21 is a diagram of a network apparatus 2100 (e.g., a network server or a programmable network switch, etc.) according to an embodiment of the disclosure. The network apparatus 2100 is suitable for implementing the disclosed embodiments as described herein. The network apparatus 2100 comprises ingress ports/ingress means 2110 coupled to receiver units (Rx)/receiving means 2120 for receiving data; a processor, logic unit, or central processing unit (CPU)/processing means 2130 (coupled to the Rx/receiving means 2120) to process the data; transmitter units (Tx)/transmitting means 2140 and egress ports/egress means 2150 (coupled to the processor/processing means 2130) for transmitting the data; and a memory/memory means 2160 (coupled to the processor/processing means 2130) for storing the data. The network apparatus 2100 may also comprise optical-to-electrical (OE) components and electrical-to-optical (EO) components coupled to the ingress ports/ingress means 2110, the receiver units/receiving means 2120, the transmitter units/transmitting means 2140, and the egress ports/egress means 2150 for egress or ingress of optical or electrical signals.

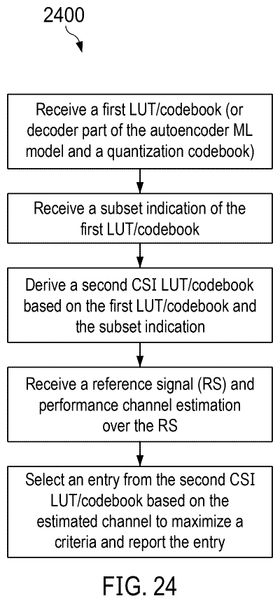

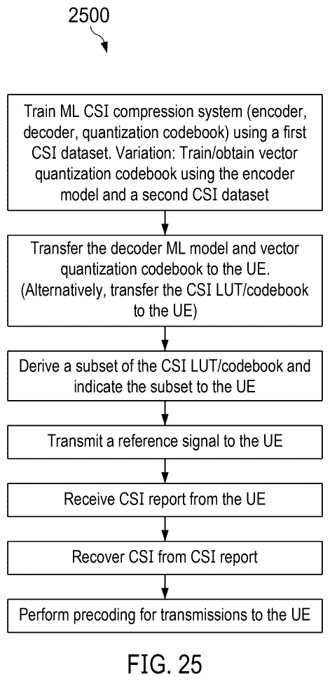

The processor/processing means 2130 is implemented by hardware and software. The processor/processing means 2130 may be implemented as one or more processor components such as CPU chips, cores (e.g., as a multi-core processor), field-programmable gate arrays (FPGAs), application specific integrated circuits (ASICs), or digital signal processors (DSPs). The processor/processing means 2130 is in communication with the ingress ports/ingress means 2110, receiver units/receiving means 2120, transmitter units/transmitting means 2140, egress ports/egress means 2150, and memory/memory means 2160. The processor/processing means 2130 comprises one or more of a CSI codebook entry selection and reporting module 2170, and a CSI compression ML model creation and precoding vector derivation module 2172. In various embodiments, one or more of the modules 2170 and 2172 are stored in onboard memory of the processor/processing means 2130. The CSI codebook entry selection and reporting module 2170 is able to implement the method 500 of FIG. 5 and/or the method 2400 of FIG. 24. The CSI compression ML model creation and precoding vector derivation module 2172 is able to implement the method 600 of FIGS. 6A and 6B and/or the method 2500 of FIG. 25.

The inclusion of the CSI codebook entry selection and reporting module 2170, and the CSI compression ML model creation and precoding vector derivation module 2172 therefore provide a substantial improvement to the functionality of the network apparatus 2100 and effects a transformation of the network apparatus 2100 to a different state. Alternatively, CSI codebook entry selection and reporting module 2170, and the CSI compression ML model creation and precoding vector derivation module 2172 are implemented as computer executable instructions stored in the memory/memory means 2160 and executed by the processor/processing means 2130.

The network apparatus 2100 may also include input and/or output (I/O) devices/I/O means 2180 for communicating data to and from a user. (I/O) devices/I/O means 2180 may be coupled to the processor/processing means 2130. The (I/O) devices/I/O means 2180 may include output devices such as a display for displaying video data, speakers for outputting audio data, etc. The (I/O) devices/I/O means 2180 may also include input devices, such as a keyboard, mouse, trackball, etc., and/or corresponding interfaces for interacting with such output devices.

The memory/memory means 2160 comprises one or more memory components such as disks, tape drives, or solid-state drives and may be used as an over-flow data storage device, may be used to store programs when such programs are selected for execution, to store computer executable instructions that are read during program execution and to store data for execution or generated during execution. The memory/memory means 2160 may be volatile and/or non-volatile and may be read-only memory (ROM), random access memory (RAM), ternary content-addressable memory (TCAM), and/or static random-access memory (SRAM).

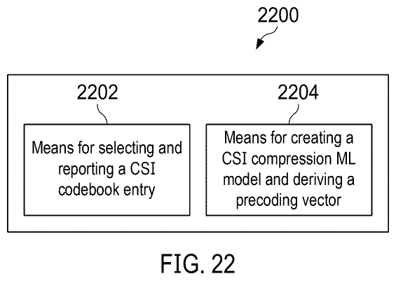

FIG. 22 is a diagram of an apparatus 2200 configured to implement one or more of the methods described herein according to embodiments of the disclosure. For example, the network apparatus 2200 is configured to implement the methods described with reference to FIGS. 5, 6A and 6B. The network apparatus 2200 may be implemented in the network device 2100. The network apparatus 2200 comprises a means 2202 for selecting and reporting a CSI codebook entry according to the method 500 of FIG. 5 and/or the method 2400 of FIG. 24. The network apparatus 2200 may further comprise a means 2204 for creating a CSI compression ML model and deriving a precoding vector according to the method 600 of FIGS. 6A and 6B and/or the method 2500 of FIG. 25.

As described above, a problem of CSI reporting is the associated communication overhead. AI/ML technologies such as an auto-encoder may be utilized to compress CSI feedback. In addition, a LUT may be generated for vector quantization of the encoder outputs and to serve as a codebook for CSI reporting. Overhead reduction of as much as 80-90% may be achieved while providing comparable performance to that of traditional method such as Type-II codebook.

Systems that produce an AI/ML generated codebook (such as systems that create a LUT for auto-encoder and vector quantization) may further improve tradeoff between performance and complexity by addressing the following issues:

1. Although the overhead of sending a LUT to a UE for CSI report may be small (e.g., 10-14 bits per layer), the complexity of searching for and selecting a best entry from the LUT may increases as the LUT size increases, although there are searching methods for larger LUTs that can reduce search complexity to a lower level without performance loss. Additionally, storage space and overhead to transfer larger LUTs also increase as LUT size increases. 2. Although 2-part models (including encoder/decoder models) of an autoencoder may be given a large and representative training dataset, a general LUT that works well in many scenarios may have a larger size. 3. Site-specific LUTs may provide improved tradeoff performance and complexity/overhead. However, transferring (or downloading) a complete LUT whenever a UE accesses a gNB may cause a relatively large communication overhead.

Such systems may use an autoencoder (including encoder and decoder) and vector quantization to generate a first, large LUT/codebook (for example, 20 (or more) bits, i.e., about 1 million entries) for CSI reporting. This first LUT/codebook may be sent (once) to a UE. A network in which the UE is operating may indicate to the UE (per gNB as an example) a subset (e.g., 1024 entries or 10 bits) of the entries of the first LUT for use in CSI reporting. The overhead to indicate the subset is much smaller than downloading a complete LUT/codebook of the same size (1024 entries) while maintaining good performance.

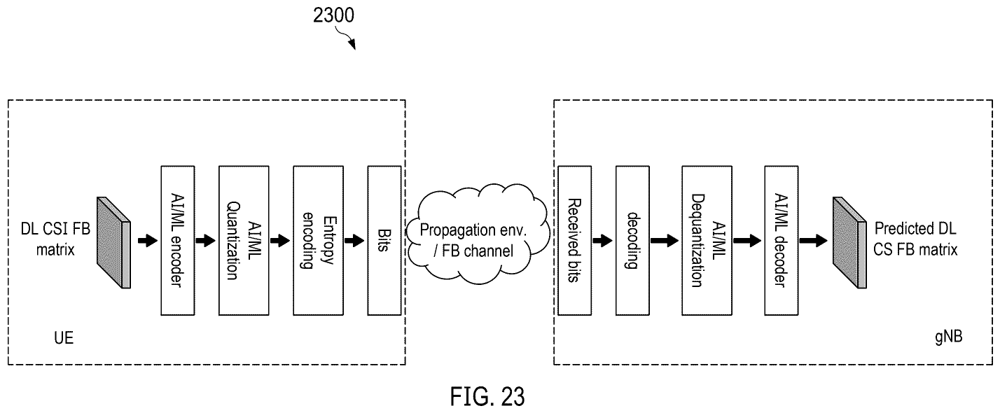

FIG. 23 depicts a system 2300 using an autoencoder and quantization according to an embodiment of the disclosure. First, an autoencoder type of an AI/ML model (including a encoder part, a decoder part, and an AI/ML quantizer) is trained on a RAN side of the system 2300 (e.g., in a gNB). The encoder part and AI/ML quantizer of the trained AI/ML model are deployed to a UE of the system 2300. This results in the gNB and the UE utilizing shared knowledge regarding a quantization map and codebook of the AI/ML model.

FIG. 24 illustrates a procedure 2400 for a UE side according to an embodiment of the disclosure. An autoencoder ML Model (including an encoder part and a decoder part) is trained (and tested) in a gNBor other base station using a first CSI dataset. In some embodiments a vector quantization codebook is trained or obtained (either jointly or separately) using outputs from the encoder part, using the first (or a second) CSI dataset.

In some embodiments, autoencoder (including encoder and decoder) and vector quantization is first used to generate a large-size LUT/codebook (for example, 20 (or more) bits, i.e., about 1 million entries) for CSI report. This first LUT/codebook is made available (once) at the UE. Network indicates (per gNB as an example) a subset (for example, of 1024 entries or 10 bits) of the entries of the first to the UE for CSI report. A subset indication is to indicate that only a subset of the entries of the first LUT/codebook is valid or used for feedback CSI. Therefore, the UE needs to search only this subset and feedback the selected entry to the gNB. An overhead to indicate the subset is much smaller than downloading a complete LUT/codebook of the same size (of 1024 entries) while maintaining good performance.

For an AI/ML generated codebook (such as LUT for auto-encoder and vector quantization), a better tradeoff of performance and complexity may be achieved. Although the overhead of LUT for CSI report is small, for example, 10-14 bits per layer, when the LUT/codebook size becomes larger, the complexity of searching and selecting the best entry from the LUT increases significantly and the storage and overhead to transfer the LUT/codebook also increase. Although the 2-part models (including encoder and decoder) of the auto-encoder may be general, given a large and representative training dataset, a general LUT/codebook that works well in many scenarios may require a large size. A site-specific LUT/codebook may better tradeoff performance and complexity/overhead. However, downloading/transferring a complete LUT/codebook every time a UE access a gNB may cause a relatively large overhead. As an example, a first LUT/codebook of relatively large size can be generated for more general scenarios and transferred to the UE. A subset of the first LUT/codebook is then derived for a specific scenario (for example, for a gNB or base station or a deployment area) to reduce the feedback overhead and associated complexity (of searching, storage, etc.) and at the same time to maintain good performance (of accuracy of CSI feedback).

In some embodiments, the decoder part and the vector quantization codebook are received by the UE. In such embodiments, the UE derives a first CSI codebook based on the decoder and the quantization codebook. In other embodiments, the UE receives a first CSI codebook that is generated in the gNB from the decoder part and the vector quantization codebook.

The UE receives a subset indication of a subset of the first LUT/codebook. The subset indication comprises information identifying which entries in the first CSI codebook (or LUT) are to be used for the UE to report CSI. The UE derives a second CSI LUT/codebook based on the first LUT/codebook and the subset indication. In some embodiments, the UE generates the second CSI LUT/codebook by including all the valid entries of the first LUT/codebook identified by the subset indication in the second CSI LUT/codebook. In other embodiments, the UE uses the subset indication as an index into the entries of first CSI LUT/codebook to effectively generate a second CSI LUT/codebook. The UE receives and measures a reference signal from a gNB to estimate channel state information. The UE selects an entry from the second CSI codebook based on the estimated CSI and a selection criteria. The UE reports the index within the second CSI LUT/codebook of the selected entry to the gNB. The gNB uses the index to recover a CSI using the quantization codebook and the decoder (or the CSI codebook derived from them) and uses the recovered CSI to perform precoding and MIMO transmission.

FIG. 25 illustrates a procedure 2500 for a gNB side according to an embodiment of the disclosure. A CSI compression ML Model (including a CSI encoder part, a CSI decoder part, and a vector quantizer) is trained (and tested) using a CSI dataset. The CSI encoder part extracts features from input data in a higher original input dimension and maps the features into a lower dimensional vector, in which elements are represented as real numbers. The vector quantizer encodes an output of the CSI encoder from a multidimensional vector space into a finite set of values from a discrete subspace of lower dimension. The vector quantizer also generates a quantization codebook. The CSI decoder first recovers the encoded vector in real-number space using the quantization codebook, then reconstructs the CSI with the original input dimension.

The CSI is a tensor of complex values with a dimension of # antenna ports×# layers×# subbands. In the case of 32 antenna ports, 2 layers, and 20 subbands, the size is 32×2×20×2=2560. The output of the encoder model can be much smaller, for example, a vector with a dimension or size of 64 or 128.

In a variation, a CSI compression ML model consisting of only the CSI encoder part and the CSI decoder part can be a trained in advance (without the vector quantizer). A quantization codebook for vector quantization may be learned or obtained by a separate step. For example, by using a clustering method on the encoder outputs of a CSI dataset. This CSI dataset can be the same (or a subset) of the CSI dataset used for encoder and decoder training. Alternatively, this CSI dataset can be a different CSI dataset, for example, a CSI dataset for a specific scenario, or a specific gNB. The vector quantization codebook size can vary depending on the scenario. For very small CSI report/feedback overhead, for example, of 10, 11, 12, or 13 bits, the vector quantization codebook will have 1024, 2048, 4096, or 8192 entries, respectively, and the dimension/size of each entry is the size of the encoder output, for example, each entry is a vector of 128 real-number values.

After the training is finished, the decoder part of the CSI compression ML model and the vector quantization codebook are transferred to the UE. The UE derives a CSI codebook by passing the vector quantization codebook through the decoder part of the CSI compression ML model. Alternatively, the CSI codebook can be directly transferred to the UE. However, the overhead of sending CSI codebook will be much larger than sending the decoder part of the CSI compression ML model and the vector quantization codebook and deriving the CSI codebook in the UE. Another alternative is that the decoder part of the CSI compression ML model and the vector quantization codebook can be sent to the UE separately. For example, a decoder part of the CSI compression ML model can be trained using a large amount of CSI data for various scenarios and sent to the UE only once. The vector quantization codebook can be trained/learned with data for a specific scenario or a specific gNB in order to have even smaller size with good performance for that specific scenario or gNB. The vector quantization can then be updated and delivered to the UE whenever needed to have better tradeoff between performance and overhead.

After the decoder part of the CSI compression ML model and the vector quantization codebook are transferred to the UE, a subset of the CSI codebook is derived. A subset indication identifying entries in the CSI codebook that are included in the subset is transferred to the UE. A reference signal is then transmitted to the UE.

Turning back to FIG. 24, the UE receives and measures the reference signal from the gNB, estimates channel state information and then selects an entry from a second CSI codebook (comprising entries in the CSI codebook that are identified in the subset indication) based on the estimated CSI and a selection criterion. The UE reports the index of the selected entry to the gNB. The criterion may be, for example, maximizing the received SINR (or CQI), maximizing the data rate of the transmission (or MCS), maximizing GCS between the CSI and the codebook entries, or other suitable criteria. An exhaustive search may be performed to select a best value of the criteria. Such a search is feasible when the codebook size is relatively small. However, when the codebook size is larger, for example, larger than 20 bits (or more than 1 million entries), there are methods that can be used to reduce searching complexity.

In addition, a measure of CSI report accuracy, for example, GCS can be reported together with the index of the selected entry in the CSI codebook, to facilitate a better use of the CSI report in the gNB. One example is to set a threshold of GCS value and report 1 when GCS of the reported CSI is no less than the threshold and report 0 otherwise. In the case of low CSI report accuracy, gNB can perform scheduling and MIMO/precoding differently. Alternatively, the UE may report CSI using a different approach. For example, a wideband CSI may be selected and reported using a wideband codebook (a NR Type-I codebook or an AI/ML generated codebook for wideband report). At the same time, the need for CSI compression model (or just the quantization codebook) retraining can be assessed to improve CSI report accuracy.

Returning to FIG. 25, the gNB uses the index to recover a CSI using the quantization codebook and the decoder (or the CSI codebook derived from them). The gNB then uses the recovered CSI to perform precoding and MIMO transmission.

As discussed with reference to FIG. 24, in some embodiments, a first CSI LUT/codebook (which may be a of a relatively large size (e.g., greater than or equal to 20 bits) may be sent to the UE once. The first CSI LUT/codebook is generated using a sufficiently large amount of training data to enable it to work well for various scenarios, but has a drawback of incurring high searching complexity.

For specific scenarios (e.g., for a specific gNB), a subset (of smaller size) of the first CSI LUT/codebook may be sufficient. The network (or the gNB) may use local data to derive the subset. A subset indication comprising a size and entries of the subset is sent to the UE. For a first CSI LUT/codebook of M bits (or K entries with K<=2\hat{ }M) and a subset of N bits (or L entries with L<=2\hat{ } N), the indication of the subset can be derived as following.

In some embodiments, the subset indication comprises a bit map of length 2\hat{ }M (or of length K) with up to 2\hat{ }N (or L) bits that equals to 1. If the k-th bit of the bitmap is set to 1, then the k-th entry of the first CSI LUT/codebook is a valid entry for the subset of the first CSI LUT/codebook (i.e., this entry is to be included in the second CSI LUT/codebook). If the k-th bit of the bitmap is set to 0, then the k-th entry of the first CSI LUT/codebook is not a valid entry for the subset of the first CSI LUT/codebook (i.e., this entry is not to be included in the second CSI LUT/codebook). In such case, the overhead is about 1 megabit, when M=20.

In such embodiments, the first CSI codebook comprises K entries and the second CSI codebook comprises L entries, and the subset indication comprises a bitmap of length K bits with L bits equal to 1, where each bit of the subset indication corresponds to an entry of the first CSI codebook, and the entries in the first CSI codebook whose corresponding bits in the subset indication are equal to 1 are entries in the second CSI codebook.

In other embodiments, a list of up to 2\hat{ }N (or L) fields may be used as the subset indication for the second CSI LUT/codebook. Each field comprises M bits to indicate an entry from 2\hat{ }M (or K) entries of the first CSI LUT/codebook as a valid entry for the subset (or the second CSI LUT/codebook). In such an embodiment, the overhead is 2\hat{ }N*M (or L*M). If M=20 and N=12, the overhead is about 80 kilobits.

In still other embodiments, two indices may be used as the subset indication. Each of the two indices comprises M bits, to indicate an entry from 2\hat{ }M (or K) entries of the first CSI LUT/codebook. The first index indicates a first entry of the subset (or the second CSI LUT/codebook) within the first CSI LUT/codebook and the second index indicates a final entry of the subset (or the second CSI LUT/codebook) within the first CSI LUT/codebook. All the entries in the first CSI LUT/codebook between the first entry and the final entry are included in the subset. In such embodiments, the overhead is 2*M bits. E.g., if M=20, the overhead is 40 bits.

In further embodiments, one index and one length indicator may be used as the subset indication. The index comprises M bits to indicate an entry from 2\hat{ }M (or K) entries of the first CSI LUT/codebook. The index indicates the first entry of the subset (or the second CSI LUT/codebook) within the first CSI LUT/codebook. The length indicator comprises N bits and indicates the size (e.g., number of entries) of the subset (or the second CSI LUT/codebook). All the k-th entries, k=index_{begin}, index_{begin}+1, . . . , index_{begin}+size−1 of the first CSI LUT/codebook belong to the subset, where index_{begin} is an index of the first entry of the subset and size is a size of the subset. In such embodiments, the overhead is M+N bits. E.g., if M=20 and N=12, the overhead is 32 bits.

Thus, in various embodiments, the subset indication identifies entries in the first CSI LUT/codebook that are included in the second CSI LUT/codebook. The UE derives the second CSI LUT/codebook by including therein only the entries in the first CSI LUT/codebook that are identified in the subset indication.

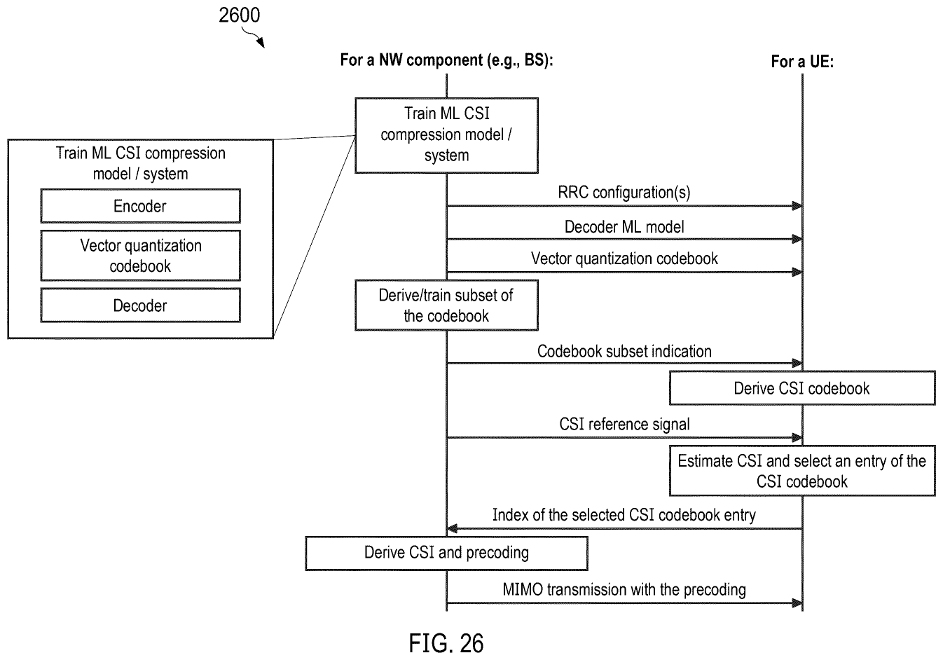

FIG. 26 illustrates a procedure 2600 embodying general steps to obtain and use an artificial intelligence (AI)/ML (autoencoder) generated CSI codebook according to the disclosure. The procedure includes elements discussed with reference to FIGS. 3C and 4A. The procedure 2600 adds steps to the procedure 400 of FIG. 4A. After the decoder part of the CSI compression ML model and the vector quantization codebook are delivered to the UE, the gNB (or BS) derives (or trains) a subset of the vector quantization codebook and sends a subset indication of the derived subset to the UE, using techniques as described above.

In some embodiments, as described with reference to FIG. 5, the UE derives a first CSI codebook based on the CSI compression ML model and the vector quantization codebook. After receiving the subset indication, the UE derives a second CSI codebook, based on the first CSI codebook and the subset indication. In other embodiments, as described with reference to FIG. 24, the UE receives the first CSI codebook and the subset indication and derives the second CSI codebook, based on the first CSI codebook and the subset indication.

The disclosed embodiments may be a system, an apparatus, a method, and/or a computer program product at any possible technical detail level of integration. The computer program product may include a computer readable storage medium (or media) having computer readable program instructions thereon for causing a processor to carry out aspects of the present disclosure. The computer readable storage medium may be a tangible device that can retain and store instructions for use by an instruction execution device. While several embodiments have been provided in the present disclosure, it may be understood that the disclosed systems and methods might be embodied in many other specific forms without departing from the spirit or scope of the present disclosure. The present examples are to be considered as illustrative and not restrictive, and the disclosure is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method performed by a wireless device, the method comprising:
deriving a channel state information (CSI) codebook based on a decoder and a vector quantization codebook;
receiving a reference signal from a base station;
deriving an estimated channel according to the reference signal;
selecting a CSI codebook entry from the CSI codebook based on the estimated channel and a selection criterion; and
reporting an index of the CSI codebook entry to the base station.

2. The method of claim 1, further comprising:
receiving the decoder; and
receiving the vector quantization codebook.

3. The method of claim 1, wherein the CSI codebook is a first CSI codebook, the method further comprising:
receiving a subset indication of a subset of the first CSI codebook; and
deriving a second CSI codebook from the first CSI codebook and the subset indication,
wherein selecting a CSI codebook entry from the CSI codebook comprises selecting the CSI codebook entry from the second CSI codebook based on the estimated channel and the selection criterion.

4. The method of claim 3, wherein:
the subset indication comprises information identifying entries in the first CSI codebook that are included in the second CSI codebook; and
the second CSI codebook comprises only the entries in the first CSI codebook that are identified in the subset indication.

5. The method of claim 1, wherein deriving the CSI codebook comprises passing vector quantization codebook entries through the decoder.

6. The method of claim 1, further comprising reporting to the base station a measure of CSI report accuracy.

7. The method of claim 6, wherein the CSI report accuracy is a quantitative value of a squared generalized cosine similarity (SGCS) or a generalized cosine similarity (GCS) between the CSI codebook entry and the estimated channel.

8. The method of claim 1, wherein the decoder is a decoder part of an autoencoder machine learning (ML) model.

9. A method performed by a first network controller, the method comprising:
obtaining a channel state information (CSI) compression machine learning (ML) system, wherein the CSI compression ML system comprises an encoder and a decoder;
obtaining a vector quantization codebook based on the encoder;
transmitting the decoder to a wireless device;
transmitting the vector quantization codebook to the wireless device;
transmitting a reference signal to the wireless device;
receiving an index x from the wireless device;
deriving a precoding vector based on the index x, the decoder, and the vector quantization codebook; and
transmitting a signal based on the precoding vector to the wireless device.

10. The method of claim 9, wherein obtaining the CSI compression ML system comprises obtaining the CSI compression ML system using a first CSI dataset.

11. The method of claim 10, further comprising training the CSI compression ML system using the first CSI dataset.

12. The method of claim 9, further wherein obtaining a vector quantization codebook comprises training the vector quantization codebook using the encoder and a second CSI dataset.

13. The method of claim 9, wherein deriving the precoding vector comprises passing an entry of the vector quantization codebook having the index x through the decoder and, based on an output of the decoder, deriving the precoding vector.

14. The method of claim 9, further comprising, prior to transmitting the reference signal to the wireless device:
deriving a subset of a CSI codebook; and
transmitting a subset indication of the subset of the CSI codebook to the wireless device, wherein the precoding vector is derived based on the index x and the subset of the CSI codebook.

15. A method performed by a wireless device, the method comprising:
receiving a channel state information (CSI) codebook;
receiving a reference signal from a base station;
deriving an estimated channel according to the reference signal;
selecting a CSI codebook entry from the CSI codebook based on the estimated channel and a selection criterion; and
reporting an index of the CSI codebook entry to the base station.

16. The method of claim 15, wherein the CSI codebook is a first CSI codebook, the method further comprising:
receiving a subset indication of a subset of the first CSI codebook; and
deriving a second CSI codebook from the first CSI codebook and the subset indication,
wherein selecting a CSI codebook entry from the CSI codebook comprises selecting the CSI codebook entry from the second CSI codebook based on the estimated channel and a selection criterion.

17. The method of claim 16, wherein:
the subset indication comprises information identifying entries in the first CSI codebook that are included in the second CSI codebook; and
the second CSI codebook comprises only the entries in the first CSI codebook that are identified in the subset indication.

18. The method of claim 16, wherein:
the first CSI codebook comprises K entries and the second CSI codebook comprises L entries; and
the subset indication comprises a bitmap of length K bits with L bits equal to 1, where each bit of the subset indication corresponds to an entry of the first CSI codebook, and the entries in the first CSI codebook whose corresponding bits in the subset indication are equal to 1 are entries in the second CSI codebook.

19. The method of claim 15, wherein the selection criterion comprises a maximum squared generalized cosine similarity (SGCS) or a generalized cosine similarity (GCS) between the CSI codebook entry and the estimated channel.

20. The method of claim 15, wherein the selection criterion comprises a maximum signal to interference and noise ratio (SINR), a modulation and coding scheme (MCS) level, a channel quality indicator (CQI), or a data rate when the CSI codebook entry is applied as precoding for transmission over the estimated channel.
